(19) United States
(12) Patent Application Publication
(10) Pub. No.: US 2010/0027056 A1
(43) Pub. Date: Feb. 4, 2010

(54) Image forming apparatus, program, and preview display method

(75) Inventors: Kumiko Ogino, Osaka-shi (JP); Takaya Nakatani, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/462,113

(22) Filed: Jul. 29, 2009

(30) Foreign Application Priority Data
Jul. 30, 2008 (JP) 2008-196855

(51) Int. Cl. G06F 15/00; G06F 17/00

(52) U.S. Cl. 358/1.15; 715/274

(57) ABSTRACT

Provided is an image forming apparatus that enables to confirm a finish state in a preview reliably so that unnecessary image formation processing due to setting errors by a user is able to be prevented and that processing load for performing a preview display at high speed is reduced. On a preview screen before performing image formation, a preview image showing the entire page of image data is displayed. When a information about finishing such as forming a punch hole, staple, and a paper fold are set to recording paper on which the image data is printed, these as information about finishing are displayed out of a recording paper area of the preview image. In addition, for example, an arrow indicating a position of the actual punch hole to the recording paper is also displayed as a part of the information about finishing together with the punch hole.

### CROSS-NOTING PARAGRAPH

This non-provisional application claims priority under 35 U.S.C. §119 (a) on Patent Application No. 2008-196855 filed in JAPAN on Jul. 30, 2008, the entire contents of which are hereby incorporated herein by reference.

### FIELD OF THE INVENTION

The present invention relates to an image forming apparatus having a function of previewing image data read from an original image before performing image formation, a program to be incorporated into a computer that is connected to the image forming apparatus, and a preview display method.

### BACKGROUND OF THE INVENTION

Conventionally, some image forming apparatuses such as copiers have a function of displaying a preview of image data before performing image formation.

For example, there is an image forming apparatus in which, in performing image formation (printing) of image data of an original read by a scanner or image data sent from an external device, a preview of the image data for performing image formation is displayed so that the image formation can be performed after a user confirms the display.

There is also an image forming apparatus that makes it possible, in performing image formation of image data by the image forming apparatus, to perform various finish processing in accordance with a setting by a user. For example, there is processing of stapling or punching the paper (recording paper) to be used for image formation. There are also inter-leaf processing for inserting sheets of different kind of paper in predetermined positions among sheets of paper for performing image formation and OHP inter-leaf processing for inserting protect paper between sheets of OHP paper. In addition, processing for placing a sheet of different kind of paper as a front cover on the top page position of sheets of paper to be used for image formation, processing for placing a sheet of different kind of paper as a back cover on the last page position, and the like.

In order to confirm such a finish state, there has been proposed a method for performing a preview display to show a finish state in advance before performing image formation. For example, there is a method in which, when a user sets stapling or punching processing as a finish state, the set finish state is displayed on a preview screen.

For example, Japanese Laid-Open Patent Publication No. 2003-87560 discloses an image forming apparatus provided with post processing means for performing post processing to the sheets subjected to image formation and post processing selecting means for selecting the type of the post processing, in which image data reducing means for converting image data accumulated in image data into image data in a reduced size and finish image display means for displaying a finish image showing a state where the post processing selected by the post processing selecting means is applied to a sheet of paper on which an image is formed on the basis of the image data yet to be reduced by processing the image data in a reduced size, are included.

In addition, a preview display apparatus disclosed in Japanese Laid-Open Patent Publication No. 2003-5471 displays a plurality of preview images showing one by one of printed paper in performing printing of a plurality of sheets. Then, positions of post processing such as stapling, punching, and stamping performed to each sheet of paper are displayed within the preview image to be shown to a user and the positions of the post processing are adjusted according to a user operation or the like so that the post processing does not affect a printed image.

In this manner, a method for displaying a thumbnail of image data on a display portion to confirm a final finish state has been widely used. In addition, when performing such a preview of the finish state on a screen, image data is displayed with a reduced image for each page. However, since the displayed preview image becomes smaller than actually printed paper, when a finish state such as a staple or a punch is displayed in a reduced image for each page, an image of the staple or the punch is so small that it is difficult for a user to confirm the finish state.

Therefore, in such a case, the finish state such as a staple or a punch is generally emphasized (enlarged) from an actual state and displayed on a preview screen.

However, in this case, even if a setting of post processing is correct, the displayed image information and the display related to the post processing overlap so that a display is performed with a lack of the image information as if there are setting errors of the post processing, thus confusing a user.

Further, when trying to emphatically display a finish state for a preview image of image data, although an image (contents) does not disappear actually even if a punch hole is formed, the finish state is displayed as if the image of that part is missing because of forming the punch hole in some cases. Similarly to this case, although an image does not disappear actually even if a staple is applied, a preview display is performed as if a part of the image is missing due to the staple in some cases. Accordingly, a technology capable of confirming a finish state in a preview image more reliably has been required.

Further, in a conventional technology, when post processing for punching a hole in sheets of paper for coping is set, the set punch hole is displayed within a recording paper area on a preview screen. On the other hand, even when an original has a punch hole originally, the punch hole that has been originally on the original is displayed within the recording paper area on the preview screen in the same manner. Therefore, the preview when copying an original with a punch hole has also a problem that it is difficult to determine whether the punch hole on the preview screen has been originally on the original or has been punched because a user has set post processing of punching.

Therefore, even if forgetting to perform a setting of punching in copying an original with a punch hole, a user misunderstands that the punch hole of an original existing on a preview screen exists because the user has performed a setting of punching and starts a copy in some cases. In such a case, a copier generates a copy to which post processing of punching is not applied. At this time, the user notices for the first time that the user has forgotten to set post processing of punching, thus it is necessary to separately perform a task of punching a hole in the copied sheets of paper or discarding the completed copied sheets and setting a punch again to make a copy.

Further, various items of post processing unrelated to image information of an original are set after a preview display or a preview is displayed again by canceling a setting of post processing that has been previously performed in some cases. Conventionally, since one with post processing set is displayed in a preview, it is necessary, at the time of such a change, to regenerate a preview screen by combining an effect of post processing with a scanned image in accordance with setting contents of the post processing.

In executing the preview display, there has been also a problem that it takes time for processing therefore.

### SUMMARY OF THE INVENTION

An object of the present invention is to provide an image forming apparatus that is able to prevent unnecessary image formation processing due to setting errors by a user and reduce processing load for generating a preview screen in order to perform a preview display at high speed, by confirming a finish state in a preview reliably, a program to be incorporated into a computer that is connected to the image forming apparatus, and a preview display method.

Another object of the present invention is to provide an image forming apparatus provided with a display portion; an operation input portion for performing operation input in accordance with a display of the display portion; an image forming portion for performing image formation of image data; and a display control portion for displaying a preview image of the image data on the display portion before performing the image formation, wherein when displaying the preview image of the image data on the display portion, information about finishing is displayed out of a recording paper area of the preview image.

Another object of the present invention is to provide the image forming apparatus, wherein the information about finishing is the information related to a staple, a punch, or a paper fold.

Another object of the present invention is to provide the image forming apparatus, wherein the information about finishing is identifiably displayed by a symbol, a text, or an icon.

Another object of the present invention is to provide the image forming apparatus, wherein information showing a position at which the information about finishing is applied to the preview image of the image data as well as the information about finishing is displayed out of the recording paper area of the preview image.

Another object of the present invention is to provide the image forming apparatus, wherein the information about finishing is emphatically displayed.

Another object of the present invention is to provide the image forming apparatus, wherein the preview image of the image data that is displayed on the display portion is able to be displayed after reduction or enlargement.

Another object of the present invention is to provide the image forming apparatus, wherein an input portion for inputting an image of the image data to be displayed for previewing is included.

Another object of the present invention is to provide the image forming apparatus, wherein the preview image of the image data that is displayed on the display portion is displayed for previewing in the same direction as an input direction of the image that is input from the input portion.

Another object of the present invention is to provide the image forming apparatus, wherein a direction of the preview image of the image data that is displayed on the display portion is decided depending on a paper ejection direction of recording paper.

Another object of the present invention is to provide the image forming apparatus, wherein when the direction of the preview image of the image data that is displayed on the display portion is different from the paper ejection direction of the recording paper, a message is displayed.

Another object of the present invention is to provide the image forming apparatus, wherein when two pages of image data are displayed in combination as a preview image on the display portion, the information about finishing is displayed out of a recording paper area of one of the image data.

Another object of the present invention is to provide the image forming apparatus, wherein the input portion is a scanner apparatus, a storage inside an apparatus, a detachable storage or memory, or a communication line.

Another object of the present invention is to provide the image forming apparatus, wherein when the preview image of the image data that is displayed on the display portion is displayed after enlargement with a predetermined magnifying power or more, the information about finishing is displayed within the recording paper area of the preview image.

Another object of the present invention is to provide a program to be incorporated into a computer that is connected to an image forming apparatus, wherein the program causes the computer to execute: a step of generating a preview image from an image data to be output by the image forming apparatus to display on a display portion of the computer; and a step of displaying information about finishing out of a recording paper area of the preview image.

Another object of the present invention is to provide a preview display method, comprising: a step in which a computer generates a preview image from image data to be output by an image forming apparatus that is connected to the computer to display on a display portion of the computer, and a step of displaying information about finishing out of a recording paper area of the preview image.

### BRIEF DESCRIPTION OF THE DRAWINGS

FIG. 1 is a schematic diagram for showing an exemplary configuration of an image processing system constructed by using a digital multi-functional peripheral as an example of an image forming apparatus according to an embodiment of the present invention;

FIG. 2 is an explanatory diagram for showing a configuration when the digital multi-functional peripheral of FIG. 1 has a post processing apparatus;

FIG. 3 is a diagram for showing the enlarged post processing apparatus of the digital multi-functional peripheral of FIG. 2;

FIG. 4 is a schematic diagram for showing another example of a post processing apparatus in the digital multi-functional peripheral of FIG. 2;

FIG. 5 is a schematic block diagram for showing an exemplary configuration of the digital multi-functional peripheral of FIG. 1;

FIG. 6 is an external view for showing an example of a touch panel and a key operation portion in the digital multi-functional peripheral of FIG. 5;

FIG. 7 is a diagram for showing an example of a standard screen of the digital multi-functional peripheral;

FIG. 8 is a diagram for showing an example of a setting screen of a 2-sided copy in the digital multi-functional peripheral;

FIG. 9 is a diagram for showing an example of a finish initial screen that is displayed when an output key is operated on the standard screen of FIG. 7;

FIG. 10 is a diagram for showing an example of a staple setting screen that is displayed when a staple sort key is selected on the finish initial screen of FIG. 9;

FIG. 11 is a diagram for showing an example of a preview screen when a preview confirm key is operated on the standard screen of FIG. 7;

FIG. 12 is an example of a preview screen that is displayed by operating an enlarging/reducing key 74 on the preview screen of FIG. 11;

FIG. 13 is a diagram for showing an example of a preview screen in an image send mode;

FIG. 14 is an example of a preview screen that is displayed by operating an enlarging/reducing key on the preview screen of FIG. 13;

FIG. 15 is a diagram for showing an example of a preview screen when information related to punched holes is displayed as information about finishing;

FIG. 16 is a diagram for showing another example of a preview screen when information related to punched holes is displayed as information about finishing;

FIG. 17 is a diagram for showing an example of a preview screen when information related to a staple is displayed as information about finishing;

FIG. 18 is a diagram for showing a preview screen when the preview screen of FIG. 17 is rotated by 90° clockwise by operating a display rotation key;

FIG. 19 is a diagram for showing still another example of a preview screen when information related to a staple is displayed as information about finishing;

FIG. 20 is a diagram for showing a preview screen when the preview screen of FIG. 19 is rotated by 90° counterclockwise by operating a display rotation key;

FIG. 21 is a diagram for showing an example of a preview screen that is displayed by operating an enlarging/reducing key on the preview screen of FIG. 15;

FIG. 22 is a diagram for showing an example of a preview screen that is displayed by operating an enlarging/reducing key on the preview screen of FIG. 18;

FIGS. 23A and 23B are diagrams for showing an example of a preview screen that displays a staple as information about finishing when middle staple printing is performed;

FIGS. 24A and 24B are explanatory diagrams in Z-shaped folding recording paper;

FIGS. 25A and 25B are reference diagrams for explaining a preview screen when information related to a Z-shaped fold is displayed as information about finishing;

FIG. 26 is a diagram for showing an example of a preview screen when information related to a Z-shaped fold is displayed as information about finishing;

FIG. 27 is a diagram for showing an exemplary configuration of a general PC, which also shows an exemplary configuration of a PC into which a printer driver of the present invention is able to be incorporated;

FIG. 28 is a diagram for showing an example of a GUI image for a print setting in the printer driver according to the present invention;

FIG. 29 is a diagram for showing an example of a GUI screen that is displayed when preview confirm is selected on a GUI screen of FIG. 28; and

FIG. 30 is a diagram for showing an example of a GUI image that is displayed when a finish display key is selected on the GUI screen of FIG. 29.

### PREFERRED EMBODIMENTS OF THE INVENTION

Now, a preferred embodiment of the present invention will hereinafter be described with reference to the drawings. An embodiment in which an image forming apparatus according to the present invention is applied to a digital multi-functional peripheral having a print function, a copy function, and a facsimile sending and receiving function, etc., will hereinafter be described specifically with reference to the drawings showing the embodiment.

### <Apparatus Configuration>

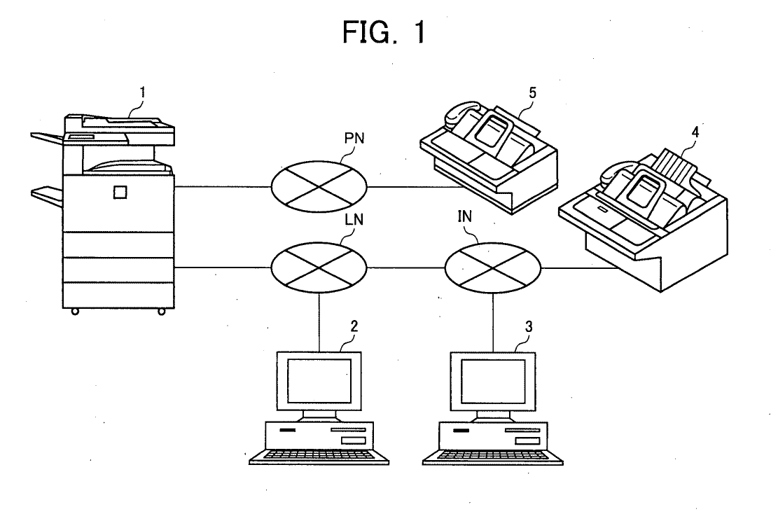

FIG. 1 is a schematic diagram for showing an exemplary configuration of an image processing system constructed by using a digital multi-functional peripheral as an example of an image forming apparatus according to an embodiment of the present invention. In FIG. 1, 1 denotes a digital multi-functional peripheral, 2 and 3 denote external computers, 4 denotes an internet facsimile apparatus (internet FAX apparatus), and 5 denotes a facsimile apparatus.

The digital multi-functional peripheral 1 is one of embodiments of the image forming apparatus of the present invention, and has a function of sending and receiving image data by facsimile (facsimile function) and/or a function of sending and receiving image data by internet FAX (internet FAX function), as well as a print function and a copy function. This digital multi-functional peripheral 1 is connected to various external devices through a communication network. For example, the external computer 2 such as a personal computer (PC) is connected to a communication network LN that is laid as a local communication network, and the external computer 3 and the internet FAX apparatus 4 are connected to an internet network IN that is connected through a not-shown gateway or the like. Further, the external facsimile apparatus 5 is connected to the digital multi-functional peripheral 1 through a public telephone line network PN.

### <Description of the Entire Apparatus>

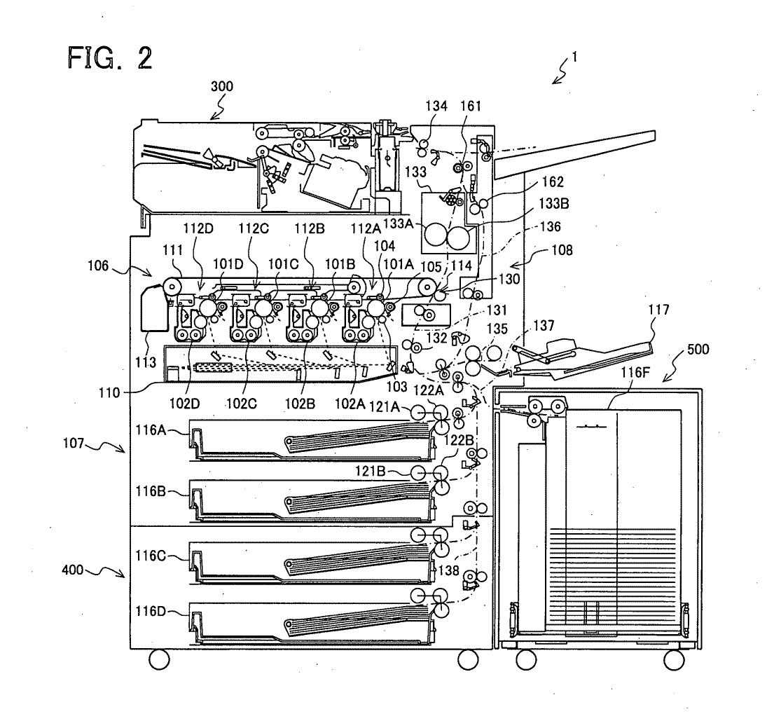

FIG. 2 is an explanatory diagram for showing an exemplary configuration when the digital multi-functional peripheral of FIG. 1 has an inner finisher.

Although the digital multi-functional peripheral 1 illustrated in FIG. 2 has a configuration in which two paper feeding apparatuses 400 and 500 as well as a post processing apparatus 300 are provided, the image forming apparatus of the present invention may be provided with at least the post processing apparatus. The digital multi-functional peripheral 1 is also provided with an image data input apparatus, which is not shown in FIG. 2, including a reading portion for reading an original as a bitmap image of RGB (R: Red, G: Green, and B: Blue) with a predetermined resolution by a scanner using a CCD (Charge Coupled Device).

The digital multi-functional peripheral 1 selectively performs multicolor and monochrome image formation by an electrophotographic system based on image information input through a network or the like and records the formed image on paper (recording paper). The digital multi-functional peripheral 1 is provided with an image forming portion 106, a paper storage portion 107, and a paper transport portion 108.

The image forming portion 106 is provided with an exposure unit 110, an intermediate transfer belt 111, and a secondary transfer roller 114, and is configured such that image forming stations 112A to 112D are arranged in a line between the intermediate transfer belt 111 and the exposure unit 110.

Each of the image forming stations 112A to 112D performs image formation based on image information of each hue of four colors in total that are cyan, magenta, and yellow, which are three primary colors of subtractive color mixing obtained by color separation of a color image, and black in addition.

The black image forming station 112A is provided with a photoreceptor drum 101A, a developing unit 102A, a charging roller 103, a primary transfer roller 104, a cleaning unit 105, and the like.

The charging roller 103 is a contact-type charger that uniformly charges the surface of the photoreceptor drum 101A to a predetermined voltage. Instead of the charging roller 103, a contact-type charger using a charging brush, or a noncontact-type charger using a charger is also applicable. The exposure unit 110 is provided with a light source such as semiconductor laser, a polygon mirror, a reflecting mirror, and the like. Image light based on the image information of black is irradiated from the exposure unit 110 to the photoreceptor drum 101A to form an electrostatic latent image corresponding to the image information of the black color hue.

The developing unit 102A supplies a black toner onto the surface of the photoreceptor drum 101A having the electrostatic latent image formed thereon and develops the electrostatic latent image into a toner image. The cleaning unit 105 collects the toner remaining on the surface of the photoreceptor drum 101A.

The intermediate transfer belt 111 forms a loop-shaped movement path. The movement path on the lower side of the intermediate transfer belt 111 passes between the photoreceptor drum 101A and the primary transfer roller 104.

A primary transfer bias with the opposite polarity to the charging polarity of the toner is applied to the primary transfer roller 104 by constant voltage control to transfer the toner image formed on the photoreceptor drum 101A onto the outer circumferential surface of the intermediate transfer belt 111.

The image forming stations 112B, 112C, and 112D of respective color hues of cyan, magenta, and yellow are similar to the image forming station 112A in configuration. However, image light modulated by image information of respective color hues of cyan, magenta, and yellow is irradiated from the exposure unit 110 to each of the image forming stations 112B, 112C, and 112D. Moreover, developing units 102B, 102C, and 102D supply toners of respective color hues of cyan, magenta, and yellow to photoreceptor drums 101B, 101C, and 101D, respectively.

And, toner images of respective color hues of cyan, magenta, and yellow are formed on the photoreceptor drums 101B, 101C, and 101D, respectively.

In a case where image information of only a part of color hues of yellow, magenta, cyan, and black is input, only the one corresponding to the input image information of the color hue out of the four image forming stations performs forming of the electrostatic latent image and forming of the toner image. For example, in the case of the monochromatic image formation, only the black image forming station 112A performs forming of the electrostatic latent image and forming of the toner image and only a black developer image is transferred onto the outer circumferential surface of the intermediate transfer belt 11.

In the case of the full-color image formation, all of the four image forming stations 112A, 112B, 112C, and 112D perform forming of the electrostatic latent image and forming of the toner image. The toner images of yellow, magenta, cyan, and black are sequentially superimposed and transferred onto the outer circumferential surface of the intermediate transfer belt 111.

The toner images transferred onto the outer circumferential surface of the intermediate transfer belt 111 are transported to the position opposite to the secondary transfer roller 114 by the rotation of the intermediate transfer belt 111. The secondary transfer roller 114 comes in contact with the outer circumferential surface of the intermediate transfer belt 111 with a predetermined nip pressure. The position where the intermediate transfer belt 111 faces to the secondary transfer roller 114 is an image forming position 130 at which image formation is performed for paper.

The paper storage portion 107 is provided with paper feed cassettes 116A and 116B and a manual tray 117 each of which stores a plurality of sheets of paper of a single kind. Moreover, an image forming apparatus 2 is optionally provided with paper feeding apparatuses 400 and 500 as an external paper storage portion.

The paper feeding apparatus 400 is arranged in the lower part of the digital multi-functional peripheral 1 and is provided with paper feed cassettes 116C and 116D inside it. The paper feeding apparatus 500 is arranged on the side of the image forming apparatus 2 and stores sheets of paper of a single kind in a large amount.

In the paper transport portion 108, a first paper transport path 131 is formed, that extends from the paper feed cassettes 116A and 116B to the post processing apparatus 300 disposed on the upper surface of the digital multi-functional peripheral 1 through the image forming position 130. On the first paper transport path 131, pickup rollers 121A and 121B, paper feeding rollers 122A and 122B, a registration roller 132, a fixing unit 133, a fourth transport roller, a first paper ejection roller 134, and the like are arranged.

In addition, a second paper transport path 135 that connects the manual tray 117 with the upstream side of the registration roller 132 in the paper transport direction of the first paper transport path 131 is formed in the paper transport portion 108.

Further, formed in the paper transport portion 108 is the third paper transport path 136 (double-sided transport path) that connects with the first paper transport path 131 in between the fixing unit 133 and the first paper ejection roller 134 on the first paper transport path 131. The paper having an image formed on one side thereof that is switched back due to the reverse turning of the first paper ejection roller is transported on the third paper transport path 136 when the double-sided image formation where an image is formed on each side of paper is performed.

In the paper transport portion 108, a fifth paper transport path 137 is also formed, that connects the paper feeding apparatus 500 with the first paper transport path 131. The paper feed cassettes 116C and 116D in the paper feeding apparatus 400 are connected with the first paper transport path through a sixth paper transport path 138 provided inside the paper feeding apparatus 4.

The paper supplied from the paper storage portion 7 and the paper feeding apparatuses 400 and 500 is transported on the first paper transport path 131 and is after the application of transferred a toner image thereon from the intermediate transfer belt 111 while it passes through the image forming position 130. Moreover, in the double-sided image formation, the paper having the toner image transferred thereon is switched back due to the reverse turning of the first paper ejection roller and is transported again onto the first paper transport path 131 through the third paper transport path 136. Then, the toner image from the intermediate transfer belt 111 is transferred onto the other side of the paper while the paper passes through the image forming position 130.

The rotation of the registration roller 132 that is arranged on the first paper transport path 31 stops its rotation when the front edge of the paper transported from the paper storage portion 107 (the paper feeding cassettes 116A and 116B and the manual tray 117), the paper feeding apparatus 400, the paper feeding apparatus 500, or the third paper transport path 136 reaches.

When the front edge of the paper having passed through the registration roller 132 reaches the image forming position 130, the rotation of the registration roller 132 is started at a timing when the front edge of the toner image adhering to the intermediate transfer belt 111 reaches the image forming position 130.

And, the paper is transported to the first paper transport path 131 such that the front edge thereof opposes to the front edge of the toner image at the image forming position 130 by the registration roller 132.

Note that, the registration roller 132 also has a function of correcting skewing of the paper by making contact with the front edge of the paper while the rotation is stopped.

The paper having the toner image transferred thereon at the image forming position 130 is guided to the fixing unit 133. The fixing unit 133 is provided with a heat roller 33A whose temperature is raised to a toner melting temperature and a pressure roller 133B that touches the heat roller 33A with a predetermined nip pressure. The paper is heated and pressurized while it passes through the fixing unit 133 and is ejected to the post processing apparatus 300 with the toner image fixed to the surface thereof.

All of the toner images adhering to the circumferential surface of the intermediate transfer belt 111 should be transferred onto the paper at the image forming position 130. However, there is a case where a part of them remain on the intermediate transfer belt 111. There is also a case where the toner image adhering to the circumferential surface of the intermediate transfer belt 111 is not transferred onto the paper and passes through the image forming position 130 by the processing described below. The toner remaining on the intermediate transfer belt 111 after passing though the image forming position 30 is collected by the cleaning unit 113.

On the other hand, the post processing apparatus 300 carries paper ejected from an optional delivery port of the digital multi-functional peripheral 1 into the apparatus to perform each post processing and stack the paper on a paper ejection tray. Examples of the post processing include stapling paper, ejecting paper to a specified paper ejection tray out of a plurality of paper ejection trays, and offsetting an ejecting position in the paper ejection tray.

### <Description of Operation of Inner Finisher>

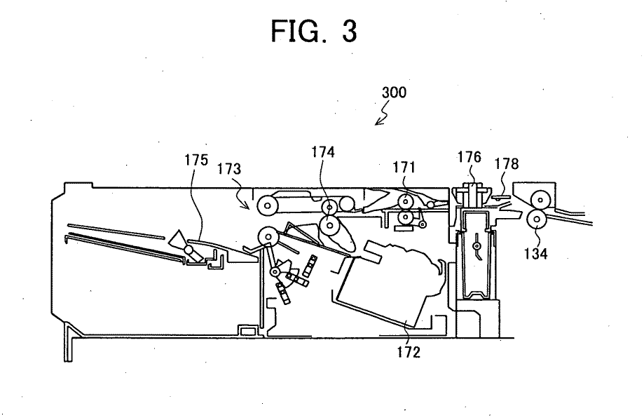

FIG. 3 is a diagram for showing the enlarged post processing apparatus shown in FIG. 2. The post processing apparatus 300 is capable of corresponding to stapling processing for stapling paper and punching processing for punching holes in paper as post processing.

The post processing apparatus 300 is provided with an inlet roller 171, a stapler 172, a punch pin 178, an adjustment processing portion 173, a paper ejection roller 174, a paper rear edge detecting sensor 176, a paper ejection tray 175, and the like. Paper ejected by the first paper ejection roller 34 of the image forming apparatus 2 is transported to the adjustment processing portion 173 by the inlet roller 171, and is sequentially stacked on a processing table to be adjusted by the adjustment processing portion 173. The adjustment processing portion 173 is provided with an adjusting plate, a paddle, a raking belt, and the like.

In the case of the stapling processing, the stapler 172 performs stapling at the specified position of the bundle of the adjusted paper. The stapled bundle of paper is ejected onto the paper ejection tray 175 by the paper ejection roller 174.

In the case of the punching processing, when the paper rear edge detecting sensor 176 detects the rear edge of the paper, transportation of the paper is temporarily stopped and the punch pin 178 punches holes in the rear edge of the paper. Thereafter, the paper is transported to the adjustment processing portion 173 to be adjusted and is then ejected onto the paper ejection tray 175 by the paper ejection roller 174.

As described above, the first paper transport path 131 is formed extending from the paper storage portion 107 to the post processing apparatus 300 through the image forming position 130 of the image forming portion 106 in the digital multi-functional peripheral 1. Paper is fed from each of the paper feed cassettes of the paper storage portion 7 and the paper feeding apparatuses 400 and 500 on the first paper transport path 131. Whether or not paper is fed from each of the paper feed cassettes is detected by the paper feed sensors provided correspondingly to each of the paper feed cassettes.

Moreover, a registration sensor is arranged near the registration roller 132 arranged on the first paper transport path 131. The registration sensor detects whether or not the front edge of paper reaches an arrangement position of the registration roller 32.

The first paper ejection roller (first paper ejection portion) 134 that is arranged on the first paper transport path is configured so as to be rotatable both forwards and backwards. The first paper ejection roller 134 is rotated forwards to transport paper to the post processing apparatus 300 through the optional delivery port. The first paper ejection roller 134 is rotated backwards with the rear edge of the paper zipped and transport the paper to the third paper transport path 136.

A first paper rear edge detecting sensor is arranged near the first paper ejection roller 134. The first paper rear edge detecting sensor detects whether or not the rear edge of the paper to be transported to the post processing apparatus 300 reaches the first paper ejection roller 134. Note that, the rear edge and the front edge of the paper are herein referred to with respect to the paper transport direction. Accordingly, the front edge and the rear edge are replaced before and after the switch-back transportation.

The third paper transport path 136 branched from the first paper transport path 131 is branched at the side of a fixing unit 33 of a first transport roller 81 that is arranged between the fixing unit 133 and the first paper ejection roller 134 on the first paper transport path 131. A first transport roller 161 is also configured so as to be rotatable both forwards and backwards in the same manner as the first paper ejection roller 134. The first transport roller 161 is rotated forwards to transport paper to the first paper ejection roller 134. The first transport roller 161 is rotated backwards to transport the paper to the third paper transport path 136.

Second and third transport rollers 162 and 163 are further arranged on the third paper transport path 136. The second and third transport rollers 162 and 163 are rotated only in one direction to transport paper to the registration roller 132 again.

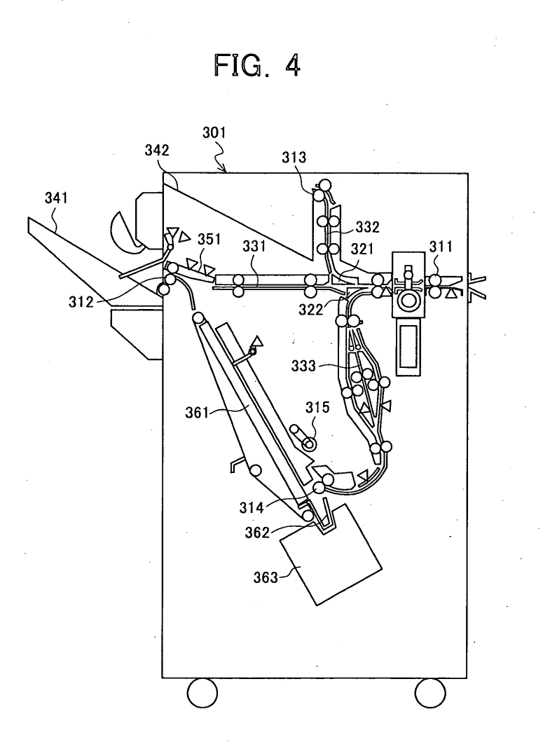

FIG. 4 is a schematic diagram for showing another example of a post processing apparatus in the digital multi-functional peripheral of FIG. 2.

A post processing apparatus 301 guides the paper ejected from the apparatus main body into the apparatus by an inlet roller 311, and causes the paper to pass straight through the inside of the apparatus without performing processing or performs the stapling processing for bundling and stapling the paper in the apparatus depending on an instruction from the digital multi-functional peripheral 1.

When a non-staple mode is selected by an instruction from the digital multi-functional peripheral 1 in the post processing apparatus 301, the paper is guided into the apparatus by the inlet roller 311, passes through separation claws 321 and 322 (which are generally positioned in the direction of a non-staple transport path 331), and is ejected and stacked on a paper ejection tray 341 which is vertically movable by a paper ejection roller 312. At this time, a paper ejection guide plate 351 is in a closed state.

When an interrupting tray ejection mode is selected by an operation portion of the digital multi-functional peripheral 1, the separation claw 321 is rotated at a predetermined angle so that the paper is transported to an interrupting tray transport path 332 and is ejected and stacked on an interruption tray 342 by a paper ejection roller 313.

When a staple mode is selected by the operation portion of the digital multi-functional peripheral 1, the separation claw 322 is operated so that the paper is carried on a staple transport path 333 and is further ejected and stacked on a staple tray 361 by a staple tray ejection roller 314.

The sheets of the paper ejected to the staple tray 361 are dropped to a lower direction of the staple tray 361 one by one by a hitting roller 315 and each sheet is pressed against a paper rear edge reference fence 362 so that the rear edge thereof is adjusted.

The adjusted paper is subjected to one-position or two-position binding processing in a predetermined position of the rear edge of the bundle of the paper by an end face binding stapler 363. The bundle of the paper after the application of the binding processing is lifted to the paper ejection roller 312 by a release claw (not shown) integrated with a release belt (not shown). Then, the bundle of the paper is pressurized against the paper ejection roller 312 by a paper ejection guide plate 361 and is ejected and stacked on the paper ejection tray by the paper ejection roller 312.

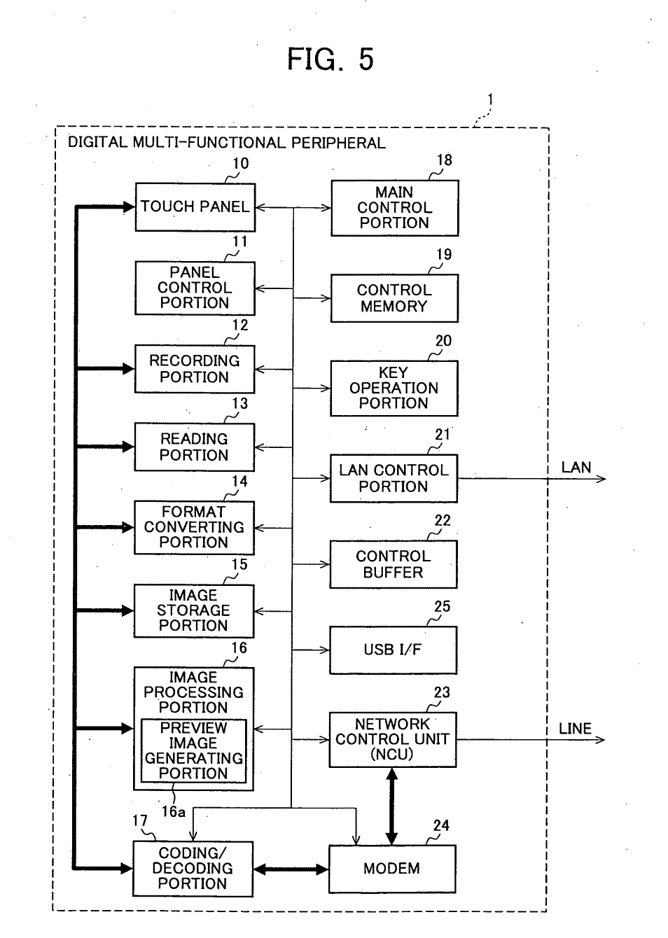

Description will be given for a function of the digital multi-functional peripheral 1, and a configuration and operation thereof. FIG. 5 is a schematic block diagram for showing an exemplary configuration of the digital multi-functional peripheral of FIG. 1.

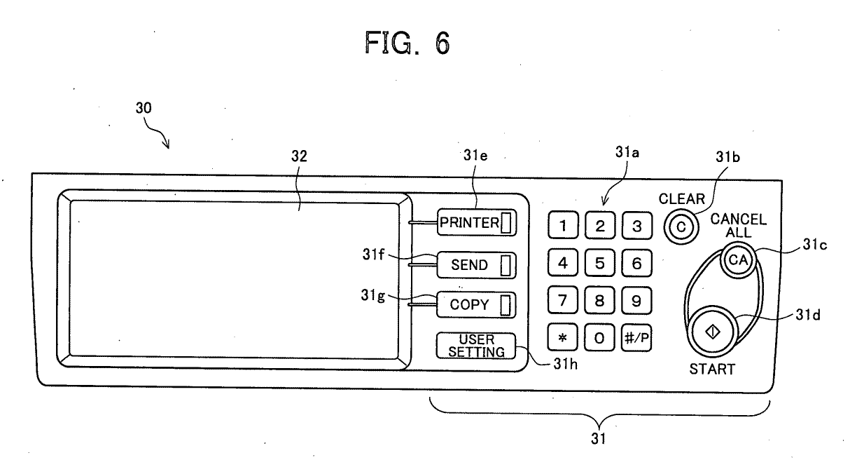

FIG. 6 is an external view for showing an example of a touch panel and a key operation portion in the digital multi-functional peripheral of FIG. 5.

The digital multi-functional peripheral 1 illustrated in FIG. 5 is provided with a touch panel 10, a panel control portion 11, a recording portion 12, a reading portion 13, a format converting portion 14, an image storage portion 15, an image processing portion 16, a coding/decoding portion 17, a main control portion 18, a control memory 19, a key operation portion 20, a LAN (Local Area Network) control portion 21, a control buffer 22, a network control unit (NCU) 23, a modem 24, and a USB (Universal Serial Bus) interface (I/F) 25.

Note that, the digital multi-functional peripheral 1 is provided with the post processing apparatus, which is not shown in FIG. 5, that performs the punching processing and the stapling processing described above.

The main control portion 18 is comprised of a CPU (Central Processing Unit), a DSP (Digital Signal Processor), or the like. The control memory 19 is comprised of a nonvolatile memory or the like, such as a ROM (Read Only Memory) or an EEPROM (Electrically Erasable and Programmable ROM). A program (firmware) and various setting data are stored in the control memory 19 so as to be readable from the main control portion 18. Among them, at least the various setting data is stored in a rewritable memory. The program and the various setting data may be stored in the image storage portion 15. The control buffer 22 is comprised of a volatile memory such as a RAM (Random Access Memory).

The above-described program is used for the main control portion 18 to carry out a command concerning generation and display of a preview image, which will be described below, according to the present invention, as well as a command concerning generation/sending/reception, etc., of a facsimile image and an electronic mail, etc., a command concerning reading of an original, a command concerning printing, a command concerning reading and printing (that is, copying) of an original, and the like, with respect to other parts. This program is written by the main control portion 18 on the control buffer 22 and is executed by referring to various setting data, which will be described below, appropriating the control buffer 22 as a data area for temporal storing (working).

The reading portion 13 reads an original as a bitmap image of RGB (R: Red, G: Green, and B: Blue) with a predetermined resolution by a scanner using a CCD (Charge Coupled Device) and outputs the read RGB image data (dot image data) to the image processing portion 16. The image processing portion 16 is comprised of an ASIC (Application Specific Integrated Circuit) or the like, and applies various items of image processing to the image data that is the object for processing. The above-mentioned ASIC may be incorporated with other parts such as the coding/decoding portion 17.

The image storage portion 15 is comprised of hard disc or the like, and stores the image data that has been read by the reading portion 13 and has passed through the image processing portion 16, the image data that has been received from outside through the LAN control portion 21, the NCU 23, etc., and the like. When the image data is stored in the image storage portion 15, the data that has been coded by the coding/decoding portion 17 may be also stored. Moreover, the image storage portion 15 may temporarily save the intermediate data generated during image processing at the image processing portion 16.

The coding/decoding portion 17 compresses image data by coding and decodes (expands) the coded image data to original image data. For example, the coding/decoding portion 17 performs coding of image data read from an original, decoding of the coded data, decoding of coded image data received from outside, and the like. In the coding/decoding portion 17, coding systems corresponding to purposes are usable, including JPEG (Joint Photographic Experts Group) that is generally used in filing, and MH (Modified Huffman), MR (Modified READ) and MMR (Modified Modified READ) that are generally used in facsimile communication. As the coding system, MH is employable in IP facsimile communication, and MH, MR, and MMR as well as JPEG and JBIG (Joint Bi-level Image Experts Group) are employable in internet facsimile communication.

The format converting portion 14 converts read image data or image data received from outside into a predetermined file format such as a PDF (Portable Document Format), a GIF (Graphics Interchange Format), or a TIFF (Tag Image File Format).

The recording portion 12 is provided with a printer apparatus that employs a printing system such as an electrophotographic system or an inkjet system, and functions as an image forming portion that records (that is, prints) image data and the like stored in the image storage apparatus 15 on recording paper. The USB I/F 25 is an I/F for making a connection to a USB device such as a USB memory, and outputs image data and the like after original reading that is stored in the image storage portion 15 to the USB device or reads a file from the USB device.

The modem 24 is comprised of a facsimile modem capable of facsimile communication, and is connected to a telephone line and is directly connected to the NCU 23. The NCU 23 is connected to the telephone line to control the line. That is, the NCU 23 is a hardware that performs an operation of closing and opening the line with an analogue public switched telephone network (PSTN), and connects the modem 24 to the public switched telephone network as the occasion demands. Such a configuration makes it possible to send image data stored in the image storage portion 15 to outside by facsimile, to receive facsimile image data from the telephone line to store in the image storage portion 15, or to print by the recording portion directly.

The LAN control portion 21 is connected to a LAN and performs communication of electronic mail data and communication of internet FAX via an internet. The internet FAX uses a LAN interface or the like to send and receive an electronic mail through a computer network such as a LAN.

The touch panel 10 or the key operation portion 20 is an operation input portion that receives an operation for selecting desired processing out of processing of reading an original, processing of sending image data and printing, etc., an operation for starting the processing, an operation for performing a setting that is necessary when each processing is executed (a selecting operation or an inputting operation), and the like.

The key operation portion 20 is provided with a key group necessary for operations. The touch panel 10 has a display portion and an operation receiving portion such as a touch sensor. The touch panel 10 is given a display control and an operation reception control by the panel control portion 11. That is, the panel control portion 11 performs the display control for the display portion and the operation reception control for the operation receiving portion in the touch panel 10.

On the display portion of the touch panel 10, a current operating state, setting information and the like are displayed. The display is realized when the panel control portion 11 performs the control to display a GUI (Graphical User Interface) image. The GUI enables changing the display and an operation received position depending on a user operation. Each GUI and the image thereof may be stored so as to be readable in an internal memory of the panel control portion or the control memory 19. In addition, as the display portion, display devices in various display systems including liquid crystal displays and organic EL (Electroluminescence) displays are employable.

The user operation received on the touch panel 10 is interpreted by the panel control portion 11 and is transmitted as an operation signal to the main control portion 18. The user operation received by the key operation portion 20 is interpreted by the key operation portion 20 itself and transmitted as an operation signal to the main control portion 18. The main control portion 18 issues a command in accordance with the operation signal obtained in this manner to other parts to cause the other parts to execute processing in accordance with the user operation. Note that, although description has been given with reference to the touch panel 10 in which the display device and the operation portion are integrated, only the display apparatus may be simply provided instead of the touch panel 10 and, in that case, where the user operation is received only by the key operation portion 20.

The touch panel 10 and the key operation portion 20 are configured as an operation panel 30 as illustrated in FIG. 6. In this example, the operation panel 30 is comprised of a key operation portion 31 (corresponding to the key operation portion 20) provided with various hardware keys and a touch panel 32 (corresponding to the touch panel 10) comprised of a liquid crystal display and a touch sensor. The present invention will hereinafter be described in detail with the touch panel 32 and the key operation portion 31 applied to the configuration of FIG. 1 instead of the touch panel 10 and the key operation portion 20.

The key operation portion 31 is provided with, as hardware keys, function switch keys 31e, 31f, and 31g for switching a print function, a sending function and a copy function, and a system setting key 31h for receiving a setting by a user, as well as a ten key 31a for inputting numeric values, a clear key 31b for clearing input set values, a cancel all key 31c for canceling all of various input settings, and a start key 31d for receiving instructions of start of copying, start of sending, etc.

An exemplary operation in the digital multi-functional peripheral 1 having the above-described exemplary configuration will be described.

### <Original Reading Operation>

An original reading operation is performed when image data of a read original is stored (filed) in the image storage portion 15, when image data of a read original is sent to outside, when image data of a read original is printed (that is, copied), and the like.

When a user operation to perform processing that requires original reading is received by the operation panel 30, the main control portion 18 gives an instruction to the reading portion 13, the image storage portion 15, the image processing portion 16, the coding/decoding portion 17, and the like to execute processing as will be described below.

The reading portion 13 optically reads an image of an original placed on a document platen or an automatic document feeder and provides the image processing portion 16 with RGB image data (bitmap data of RGB) as a result of reading. The image processing portion 16 executes various items of image processing (hereinafter, referred to as original image processing) such as A/D conversion, shading correction, and γ correction for the RGB image data. Here, the shading processing is processing to remove various distortions generated in an illumination system, an image focusing system, and an image sensing system of the reading portion 13.

As the original image processing, original determination processing and segmentation processing may be executed subsequently to the A/D conversion, the shading correction, and the γ correction. The original determination processing includes processing of determining a type of the original and processing of determining whether the original is a color original or a monochromatic original based on input image data (image data after the application of the γ correction in this case). Examples of the type of the original include a text original, a printed photograph original, and text and printed photograph original in combination thereof. The image processing portion 16 outputs a determination signal (hereinafter, referred to as original determination data) as a result of the original type determination processing and the monochromatic/color original determination processing.

The segmentation processing is processing of determining to what kind of area each pixel of the input image data (image data after the application of the γ correction in this case) belongs, and an example thereof includes processing of determining to which area including a black text area, a color text area and a halftone area each pixel belongs. The image processing portion 16 outputs segmentation data as a result of the determination. Note that, the segmentation processing may be executed based on the result of the above-described original determination processing and monochromatic/color original determination processing.

The original determination data and the segmentation data are stored in the image storage portion 15 in association with corresponding image data (image data after the application of the original image processing). At this time, the original determination data and the segmentation data are coded by the coding/decoding portion 17 and each coded data is thereafter stored in the image storage portion 15 in association with the corresponding image data. Note that, although the coding in storing in the image storage portion 15 is not essential, description will be given assuming that the image data is stored in a state of being coded. This is also the same in operations other than the original reading operation.

### <Printing Operation>

By the above-described original reading operation, processing up to filing of the image data of the read original is completed. Next, description will be given for a printing operation when the image data of the read original is printed (forming image) (that is, when the original is copied). When the user operation to perform processing requiring printing is received by the operation panel 30, the main control portion 18 gives an instruction to the recording portion 12, the image storage portion 15, the image processing portion 16, the coding/decoding portion 17, and the like to execute processing as will be described below. Note that, the main control portion 18 also gives an instruction to the reading portion 13 (original reading instruction), for example, when a copy operation is performed.

The coding/decoding portion 17 reads and decodes image data to be printed and original determination data and segmentation data corresponding thereto from the image storage portion 15, which are provided to the image processing portion 16. The image processing portion 16 executes various items of image processing (hereinafter, referred to as image processing for printing) for the decoded image data (RGB image data). As will be schematically described below, examples of the image processing for printing include image quality adjustment processing, two-color processing, color correction processing, black generation and under color removal processing, spatial filter processing, scaling processing, output tone correction processing, and halftone generation processing. The black generation and under color removal processing, the spatial filter processing, and the halftone generation processing are processing in accordance with various areas indicated by the segmentation data.

As the image quality adjustment processing, a background is detected from the decoded image data to perform background removal. Moreover, as the image quality adjustment processing, RGB adjustment (color adjustment; entire color adjustment of redness or blueness), brightness adjustment, and vividness adjustment are also performed for the image data subjected to the background removal based on setting information set by a user from the operation panel 30. At this time, adjustment in accordance with an original type indicated by the original determination data may be performed.

As the color correction processing, CMY data having components of CMY (C: Cyan, M: Magenta, Y: Yellow) which are complementary colors of RGB is generated from the RGB data after the application of the image quality adjustment processing and processing of enhancing color reproduction is performed. As the black generation and under color removal processing, black generation processing of generating black (K) data from the CMY data after the application of the color correction and under color removal processing of subtracting the K data obtained by the black generation from the original CMY data to generate new CMY data.

As the spatial filter processing, enhancement processing or smoothing processing is performed for CMYK data which is data of the four colors. When a two-color mode for outputting the image data in two colors (for example, red and black) is selected, the two-color processing is performed.

As the two-color processing, processing of converting the RGB data into CMY data that represents specified two colors (red and black in this case) is performed. In the case of the two-color mode, the black generation/under color removal processing is executed for the CMY data after the application of the two-color processing and the spatial filter processing is also executed, however, the color correction processing is not executed.

As the scaling processing, image enlarging processing or image reducing processing is performed for the CMYK data after the application of the spatial filter processing based on a printing magnifying power set by the user operation from the operation panel 30. The printing magnifying power is a magnifying power of a printed image for the image indicated by read and stored image data. Of course, the printing magnifying power is not limited to a magnifying power obtained by the user operation and is a magnifying power set as default when no operation is performed for the printing magnifying power.

As the output tone correction processing, output γ correction processing of outputting to a recording medium such as recording paper is performed for the CMYK data. As the halftone generation processing, tone reproduction processing of outputting an image by error diffusion processing and dither processing is performed for the CMYK data after the application of the output tone correction processing. In the output tone correction processing and the halftone generation processing, processing in accordance with an original type indicated by the original determination data may be performed, for example, including differentiating processing contents between a text area and other areas.

The CMYK data after the application of the halftone generation processing is provided to the recording portion 12. The recoding portion 12 receives the image data to which the image processing for printing has been given by the image processing portion 16 in this manner (the CMYK image data in this example) and generates a hard copy (prints out) by an electrophotographic system or an inkjet system. Note that, the data that is the object for the printing operation described here is not limited to the image data read by the reading portion 13, and, for example, image data (image file) that has been previously transferred from an external recoding medium, a PC connected through a network, or the like and stored in the image storage portion 15 is also applicable in the same manner.

### <Preview Display Operation for Image Data to be Printed>

Next, description will be given for an operation of displaying a preview of image data stored in the image storage portion 15 as a result of original reading on the touch panel before printing (preview display operation).

The preview display operation is performed when the user operation to perform processing requiring the preview display is received by the operation panel 30. For example, the preview display operation is also performed when a setting is made such that a preview of the image data after the original reading is firstly displayed before executing printing.

In the embodiment according to the present invention, when a preview of the image data to be printed is displayed, operation input for displaying information about finishing of paper on which an image is formed can be further received, and when the operation input for displaying a finish state is performed on the screen that displays a preview of the image data, information showing the finish state is displayed on the touch panel 32 separately from the preview image of the image data in accordance with finish conditions set to the digital multi-functional peripheral.

In the preview display operation, the main control portion 18 gives an instruction to the image storage portion 15, the image processing portion 16, the coding/decoding portion 17, the panel control portion 11, and the like to execute processing as will be described below. Note that, the main control portion 18 also gives an instruction to the reading portion 13 (original reading instruction), for example, when an operation of copying an original is performed.

The coding/decoding portion 17 reads and decodes image data to be displayed for previewing and original determination data and segmentation data corresponding thereto from the image storage portion 15, which is provided to the image processing portion 16. The image processing portion 16 executes various image processing (hereinafter, referred to as image processing for previewing) for the decoded image data (RGB image data). As will be schematically described below, examples of the image processing for previewing include image quality adjustment processing, two-color processing, color correction processing, spatial filtering processing, scaling processing, and output tone correction processing. The spatial filtering processing and the output tone correction processing are processing in accordance with various areas indicated by the segmentation data.

The image quality adjustment processing here is the same as the image quality adjustment processing in the image processing for printing. As the color correction processing, processing of converting the image data after the application of the image quality adjustment processing (RGB data) into R′G′B′ data based on display characteristics of the touch panel 32. As the spatial filtering processing, enhancement processing or smoothing processing is performed for the R′G′B′ data.

As the scaling processing, image enlarging processing/image reducing processing in accordance with a printing magnifying power is applied to the R′G′B′ data after the application of the spatial filter processing, and processing of converting a pixel number of the R′G′B′ data into a pixel number (display resolution) of the touch panel 32 is performed and image enlarging processing or image reducing processing is performed based on a preview display magnification set by the user operation from the operation panel 30 at the same time. The preview display magnification is a fixed display magnification such as twice and four times, for example, and is a display magnification of an image in the preview display. Of course, the preview display magnification is not limited to a display magnification obtained by the user operation, and is a display magnification set as default when no operation is performed for the preview display magnification.

The preview image generating portion 16a provided in the image processing portion 16 generates an image for a preview display (preview image) mainly by such scaling processing for a preview display.

When the punching or stapling processing is applied by the post processing apparatus, an image of information about finishing of a punch, a staple, or the like is not combined with a preview image generated from image data to be printed but image data for post processing such as punching or stapling is output and displayed in combination time separately in a vicinity thereof.

As the output tone correction processing, output γ correction processing of displaying image data on the touch panel 32 is performed for the R′G′B′ data of the preview image. In the output tone correction processing, processing in accordance with an original type indicated by the original determination data may be performed, for example, including differentiating processing contents between a text area and other areas.

The two-color processing is executed only when a two-color mode for outputting image data in two colors of red and black, for example, is selected. As the two-color processing, processing of converting the RGB data after the application of the image quality adjustment processing into CMY data that represents specified two colors (red and black in this case) is performed. The generated CMYK is converted into R′G′B′ data based on display characteristics of the touch panel 32 at the subsequent color correction processing.

The R′G′B′ data generated by the preview image generating portion 16a and given the output tone correction processing is provided to the touch panel 32. The panel control portion performs control for the touch panel 32 to display an image corresponding to the R′G′B′ data in a state of being incorporated in a GUI image and displays the GUI image on the touch panel 32. Note that, the data that is the object for the preview display operation described here is not limited to the image data read by the reading portion 13, and image data (image file) that has been previously transferred from an external recording medium, a PC connected through a network, or the like and stored in the image storage portion 15, for example, is also applicable in the same manner.

### <Supplement for Original Reading, Preview Display and Printing>

Although description has been given for the preview display operation separately from the printing operation, the printing operation may be performed such that the image data (CMYK data) after the application of the output tone correction processing is converted into the R′G′B′ data based on display characteristics of the touch panel 32, is processed by conversion processing corresponding to a pixel number (display resolution) of the touch panel 32 and scaling processing corresponding to a reducing/enlarging ratio in the preview display, and is displayed on the touch panel 32. Since the printing operation is completed to a certain extent and the printing operation after the preview display can be completed quickly, it is useful in a case where a setting is made such that a preview is previously displayed, for example, when the copy operation is performed.

In addition, an example in which the coded image data, the original type data and the segmentation data are stored in the image storage portion 15 in association with one another has been taken as the original reading operation, based on which the printing operation and the preview display operation have been also described. As an alternative method thereof, coding may be performed only for the image data read by the reading portion 13, which is temporarily stored in the image storage portion 15. In this case, it may be configured such that the image processing portion 16 applies the original type determination processing and the segmentation processing for the image data that has been read from the image storage portion 15 and decoded by the coding/decoding portion 17 in the printing operation and the preview display operation. In addition, such an alternative method is also applicable in sending image data such as sending by facsimile or sending by internet FAX.

### <Description for Preview Display According to the Present Invention>

The digital multi-functional peripheral 1 has the preview image generating portion 16a that reads image data for performing image formation from the image storage portion 15 and generates a preview image thereof. The preview image generated by the preview image generating portion 16a is sent to the touch panel 32 by control from the main control portion 18, controlled to be displayed in a state of being incorporated in a GUI image by the panel control portion 11, and displayed on a display portion of the touch panel 32. The touch panel 32 is an example of the display portion that displays a preview of image data targeted for image formation.

The image data to be output may be image data input from any of a scanner apparatus illustrated as the reading portion 13, detachable storage apparatus illustrated as the USB memory connected to the USB I/F 25, and a communication line illustrated as the LAN or the line. The image data to be output may also be image data read from a storage apparatus illustrated as the image storage portion 15 provided in the digital multi-functional peripheral 1.

### <Specific Example of Preview Display>

Description will hereinafter be given for information showing a finish state (information about finishing) that is displayed together with a preview image of image data and for the flow of a preview display thereof with reference to specific examples. The following example of a screen display shows an exemplary display of the touch panel 32 in the digital multi-functional peripheral 1 according to an embodiment of the present invention.

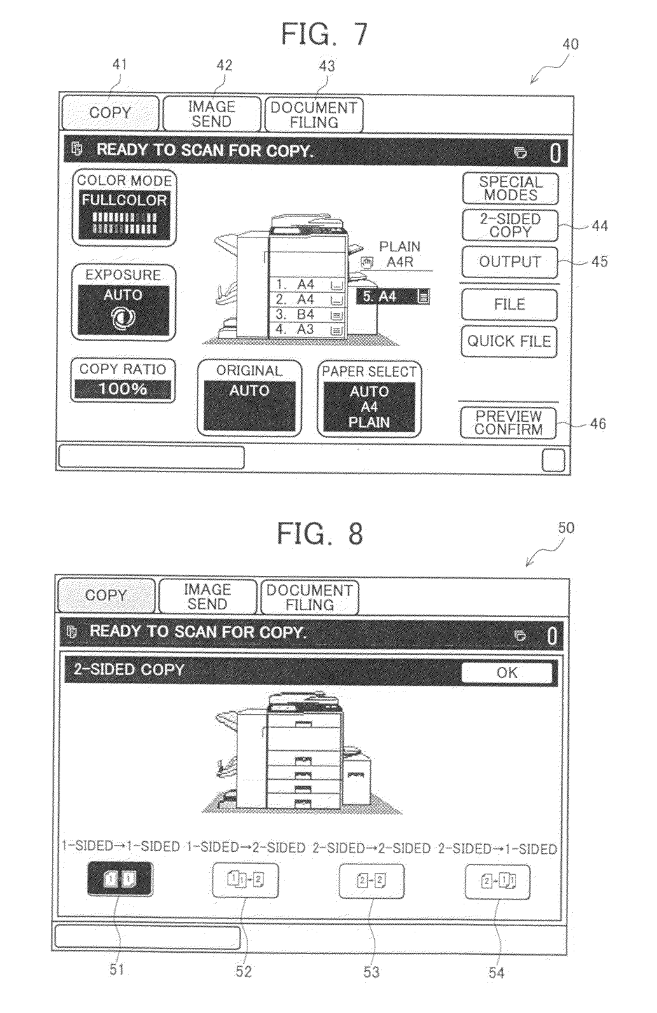

FIG. 7 is a diagram for showing an example of a standard screen of the digital multi-functional peripheral. A standard screen 40 is displayed on the touch panel 32 of the digital multi-functional peripheral 1 when a power source of the digital multi-functional peripheral 1 is turned on or reset. A copy key 41 in the upper part is selected on the standard screen 40 so that various condition settings for performing a copy are possible.

In addition to the copy, by selecting an image send key 42 or a document filing key 43 on the standard screen 40, it is possible to shift to an image send mode for performing image send such as FAX or a document filing mode for performing saving or confirmation of data.

The standard screen 40 is further provided with a 2-sided copy key 44 for setting a 2-sided copy, an output key 45 for performing a setting of post processing such as punching or stapling, and a preview confirm key 46 which will be described below.

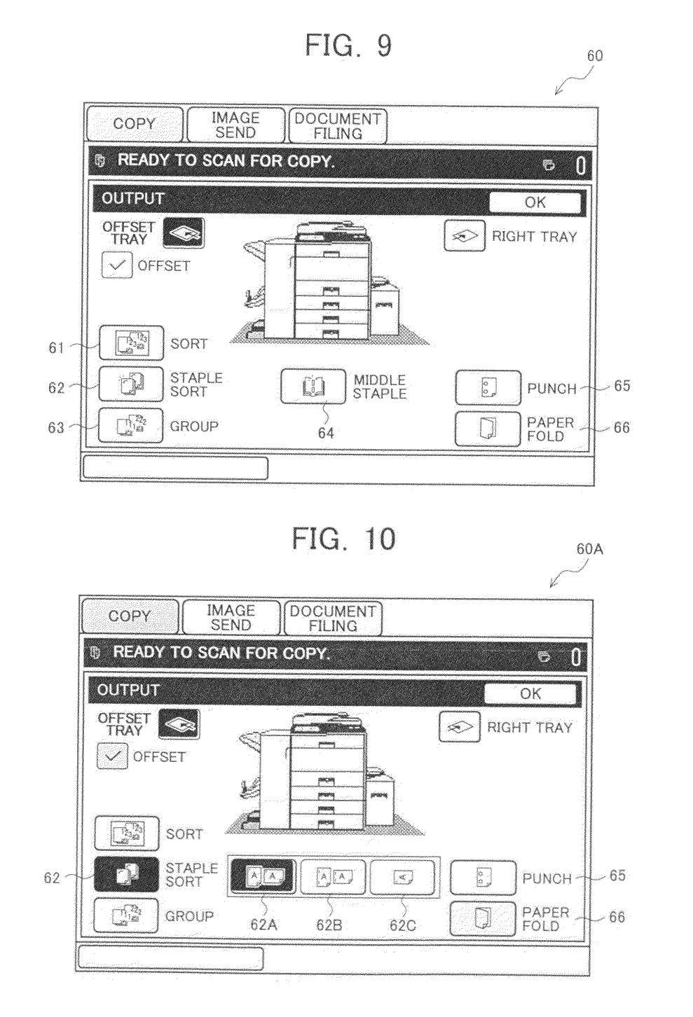

FIG. 8 is a diagram for showing an example of a setting screen of a 2-sided copy in the digital multi-functional peripheral, and, for example, by operating (touching) the 2-sided copy key 44 on the standard screen 40 of FIG. 7, a 2-sided copy setting screen 50 as shown in FIG. 8 can be opened. Here, by operating a “1-sided to 1-sided” key 51 for setting an automatic 1-sided copy from a 1-sided original, a “1-sided to 2-sided” key 52 for setting an automatic 2-sided copy from a 1-sided original, a “2-sided to 2-sided” key 53 for setting an automatic 2-sided copy from a 2-sided original, a “2-sided to 1-sided” key 54 for setting a 1-sided copy from a 2-sided original, or the like, the user is able to perform a desired copy setting.

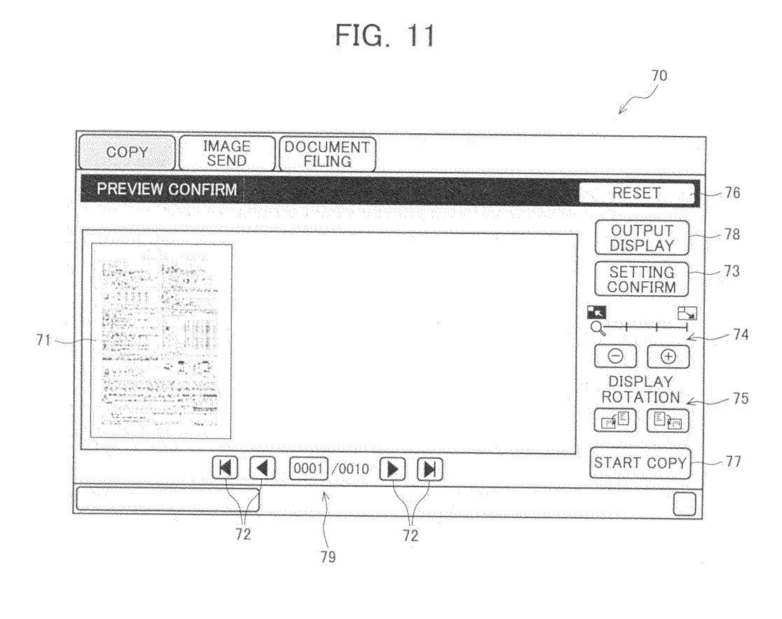

FIG. 9 is a diagram for showing an example of a finish initial screen that is displayed when the output key 45 is operated (touched) on the standard screen 40 of FIG. 7.

By operating a sort key 61 for sorting and outputting printed paper (recording paper), a staple sort key 62 for performing a staple setting for the sorted recording paper, a group key 63 for instructing output for each of the same copies, a middle staple key 64 for applying a staple in the center of a copy output of two spread pages to instruct a binding in middle position, a punch key 65 for performing a setting for punching, a paper fold key 66 for setting a paper fold, and the like on the output initial screen 60 of FIG. 9, the user is able to perform a desired finish concerning a copy output.

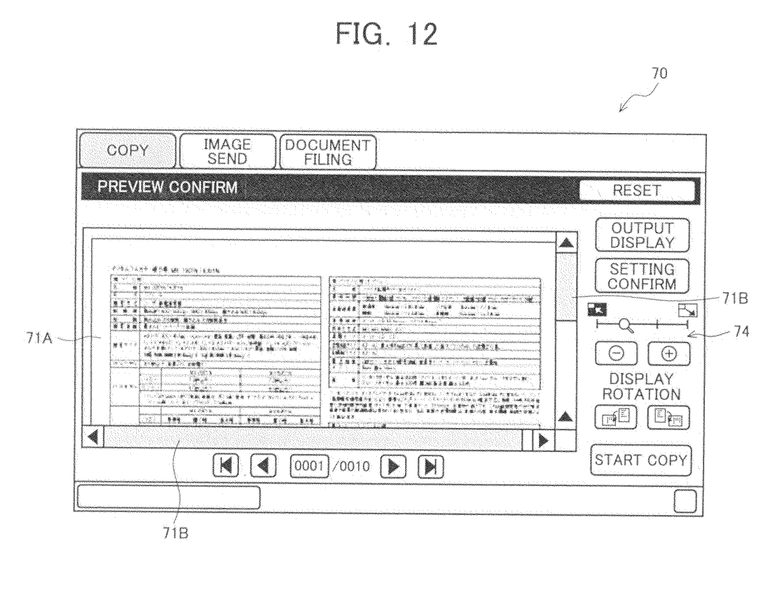

In addition, by selecting the staple sort key 62 on the finish initial screen 60 of FIG. 9, a staple setting screen 60A shown in FIG. 10 is displayed.

On the staple setting screen 60A of FIG. 10, the staple sort key 62 itself is displayed in reverse so that the user is able to confirm that the staple sort key 62 is selected, and, for example, when an original is set on the reading portion 13 in reading a copy original, if the copy original is placed in the direction shown by from a key 62A to a key 62C, the key 62A for instructing to apply a staple at one position on the upper left of the copy output, a key 62B for instructing to apply staples at two positions on the left side of the copy output, or the key 62C for instructing to apply a staple at one position on the lower left of the copy output is able to be selected, respectively.

Moreover, by selecting the punch key 65, a setting for forming a predetermined punch hole in printed paper can be performed, and by selecting the paper fold key 66, various folding methods can also be set for printed paper.

By operating the preview confirm key 46 displayed on the standard screen 40 of FIG. 7 by using the touch panel 32, the user is able to display a preview of image data.

The image data displayed for previewing at this time is image data of an original image that has been read by the reading portion 13 (FIG. 5) and stored in the image storage portion 15. In addition, image data that has been received from an external device by facsimile, internet FAX, or the like and stored in the image storage portion 15 may be targeted for the preview.

For example, when trying to copy an original, the user sets the original on the reading portion 13 and firstly operates the preview confirm key 46. Then, by pressing a start key 31d (FIG. 6) for starting a copy, the original image is read and image data stored in the image storage portion 15 is displayed for previewing. Alternatively, when performing an operation to print image data received from an external device, by operating the preview confirm key 46 and then pressing the start key 31d, the image data can be displayed for previewing.

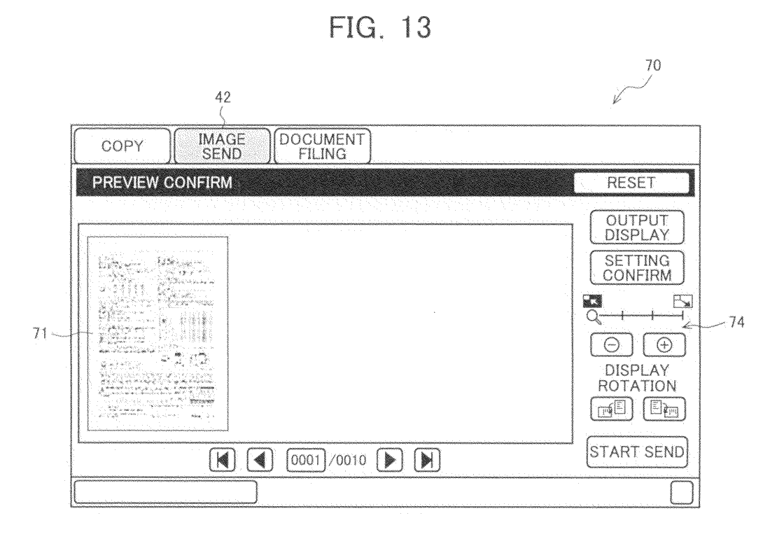

FIG. 11 is a diagram for showing an example of a preview screen that is displayed when the preview confirm key is operated on the standard screen of FIG. 7. When the user operates the preview confirm key 46 on the standard screen 40, a preview screen 70 as shown in FIG. 11 is displayed. On the preview screen 70, a preview image 71 of image data to be printed is displayed. The preview image 71 is displayed by performing image processing for a preview as described above for the image data, which shows reduced image data for each page. The preview image 71 is displayed for each page in this manner and the user is able to display the preview image of an arbitrary page by operating a page switch key 72 as appropriate. It is also possible to confirm a currently displayed page of the image data by a page display 79.

Moreover, a setting confirm key 73, an enlarging/reducing key 74, a display rotation key 75, and the like are displayed on the preview screen 70 shown in FIG. 11, and by operating these keys appropriately, the user is able to confirm a setting of the preview image 71 or to confirm by enlarging, reducing or rotating the preview image 71. When a necessity of setting print conditions again after confirming the preview image 71 arises, the user is able to open a screen for setting the print conditions again by operating a reset key 76. Then, it is possible to reset the print conditions using the reset screen to display the preview image 71 based on the reset print conditions.

In addition, a copy start key 77 is displayed on the preview screen 70 shown in FIG. 11, and when the user operates the copy start key 77, processing for performing image formation (printing) of the image data displayed for previewing is started.

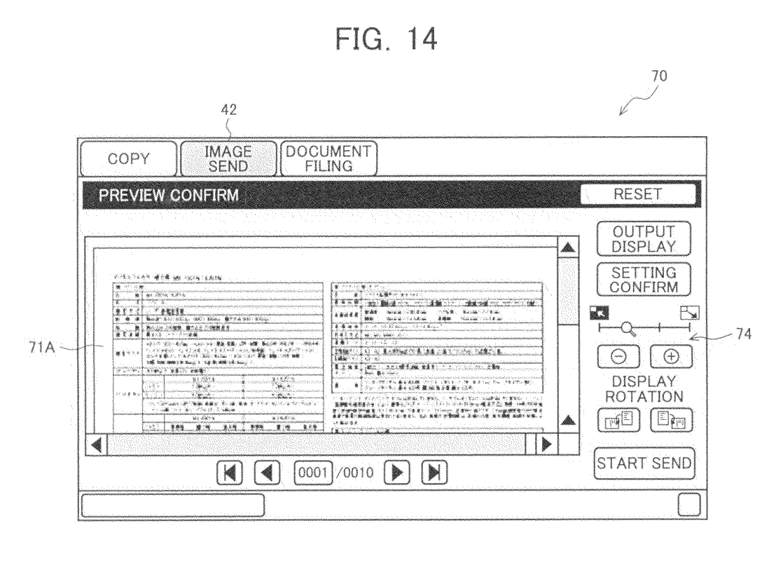

For example, by operating the enlarging/reducing key 74 on the preview screen 70 of FIG. 11, it is possible to display an enlarged preview image 71A on the touch panel as shown in FIG. 12.

Note that, four steps of enlarging/reducing can be selected by the enlarging/reducing key 74, and the entire copy original is displayed in the case of the most reduced size. Although only a part of the original is displayed in the enlarged preview image 71A, it is also possible to display other parts by operating a scroll bar 71B.

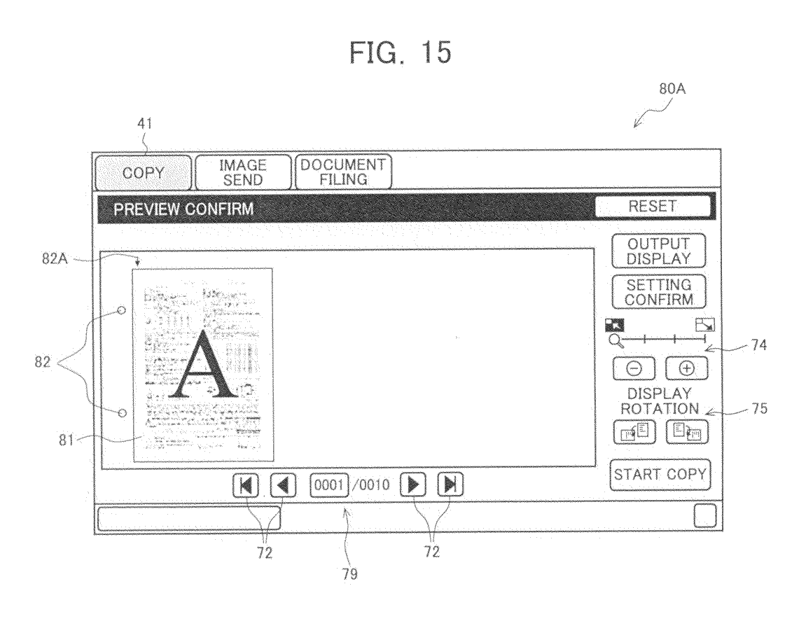

Further, the display of a preview image is possible not only in the copy mode but also in the image send mode or the document filing mode described above, and FIG. 13 shows an example of a display screen when the image send key 42 is selected and the preview confirmation is operated, and the preview image 71 of image data that is the object for image send is displayed on the preview screen 70.

In addition, similarly to the preview screen when the copy mode is selected as shown in FIG. 11, the setting confirm key, the enlarging/reducing key 74, the display rotation key, and the like are displayed on the preview screen 70, and by operating these keys appropriately, the user is able to confirm a setting of the preview image 71 or to confirm by enlarging, reducing or rotating the preview image 71.

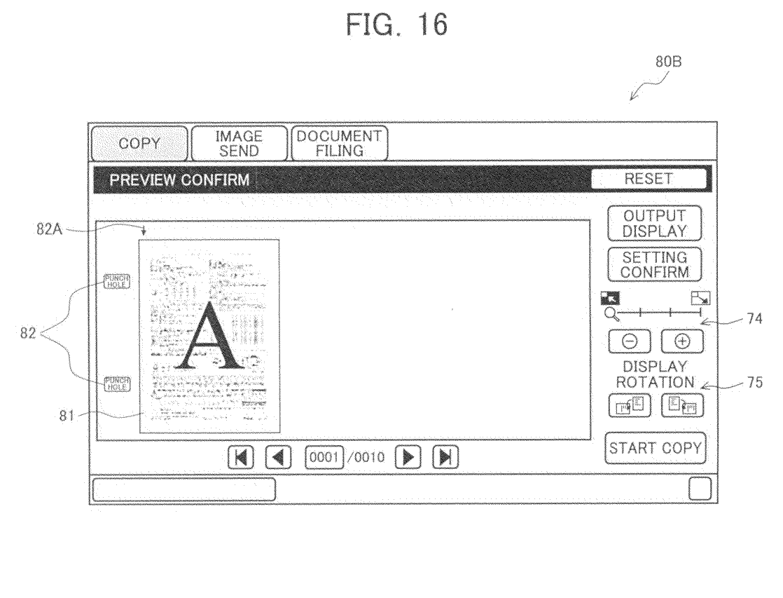

FIG. 14 is a diagram for showing a display screen when the enlarged preview image 71A is displayed on the touch panel in the image send mode by operating the enlarging/reducing key 74 on the preview screen 70 of FIG. 13.

Next, a finish display key 78 for performing a display of a finish state serving as characteristics of the embodiment according to the present invention is displayed on the preview screen 70 shown in FIG. 11.

By operating the finish display key 78 in a state where the preview image 71 of image data is displayed on the preview screen 70, the user is able to confirm the finish state after printing as a preview. Preview information of the finish state is displayed as information different from the preview image 71 of the image data.

The digital multi-functional peripheral 1 displays the finish display key 78 in an active state only when predetermined finish processing is set to a copy job of image data (job of image formation) on the preview screen 70. As the predetermined finish processing, the stapling processing, the punching processing, the paper folding processing, or the like as described above can be set.

For example, a selecting operation by the user is possible in an active state, while in an inactive state, the active state can be identified by displaying the display in a grayed out manner or deleting the display.

After the user operates the finish display key 78 in an active state to display information showing the finish state, by operating the finish display key 78 again, the original preview screen 40 as shown in FIG. 11 can be returned.

That is, when the information showing the finish state is displayed together with the preview image of the image data on the display portion of the touch panel 32, if an operation of selecting the finish display key 58 is performed again, the display control portion (the preview image generating portion 16a and the panel control portion 11) of the digital multi-functional peripheral 1 performs control to return to a display state in which the preview image of the image data is displayed and the information showing the finish state is not displayed.

Alternatively, when the display showing the finish state is displayed on the display portion, if an operation of selecting the finish display key 78 is performed again, the display control portion is also able to control to delete at least the display showing the finish state that is displayed on the display portion of the touch panel 10.

### Example 1

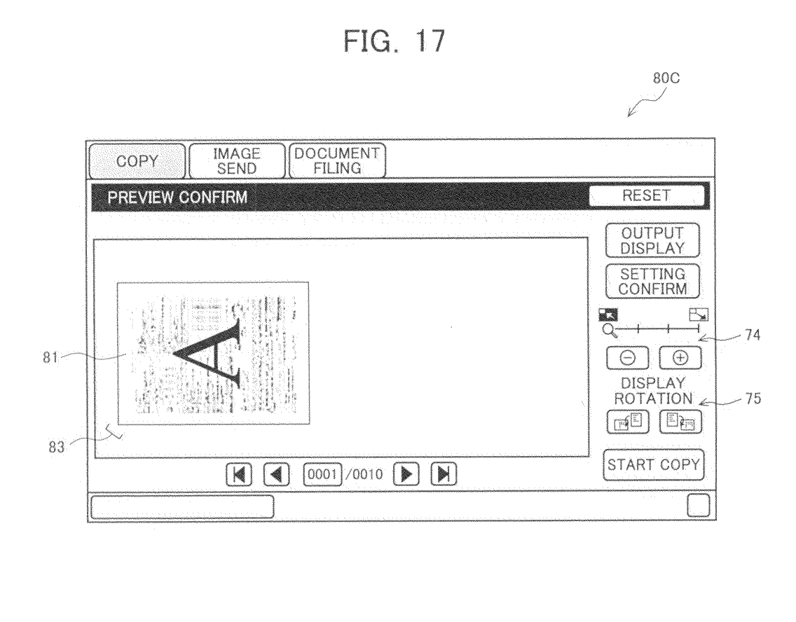

FIG. 15 is a diagram for showing an example of a preview screen when information related to punch holes is displayed as an example of information about finishing. By setting print conditions and operating the preview confirm key 46 on the standard screen 40 shown in FIG. 7, the user is able to display a preview image of image data. The display screen at this time is, for example, the preview screen 70 as shown in FIG. 11. By operating the finish display key 78 on the preview screen 70, it is possible to display a preview screen 80A that displays punch holes 82 as information showing a finish state (information about finishing) as shown in FIG. 15.

Note that, “A” is displayed in a preview image 81 so that a direction of an image is easily understood.

Here, on the preview screen 80A, the preview image 81 is displayed in a direction that an original is read on the reading portion 13. Moreover, although the punch holes as information about finishing are actually formed at two positions on the left side within a recording paper area displayed by the preview image 81, the punch holes 82 in this example are displayed in a vicinity out of the recording paper area of the preview image 81 and at a position maintaining a direction to a center part of paper where punch holes are formed within the same screen. Moreover, a size of the punch holes 82 to the recording paper area can be displayed larger than a size of the actual punch holes to recording paper.

An arrow 82A displayed out of the recoding paper area indicates a position in a lateral direction of the recoding paper area where the actual punch holes are formed, and is used with the display of the punch holes 82 in combination so that the user is able to easily determine whether or not there is missing of the image due to the punch holes while viewing the display of the arrow 82A.

Since the information about finishing is displayed out of the recording paper area of the preview image in this manner, it is possible to display the information about finishing larger compared to the case where the information about finishing is displayed within the recording paper area of the preview image, thus enhancing visibility for the information about finishing. When the enlarged information about finishing is displayed within the preview image, the preview is displayed as if a part of the image is missing due to the information about finishing, however it is less likely to occur in this embodiment.

Moreover, when punch holes have been already formed in an original, the user is able to easily recognize that the punch holes within the recording paper area are the holes existing in the original that have not been set by the user. When the punch holes are displayed out of the area, the user easily recognizes that a punching setting has been performed.

Further, since it is not necessary to perform image synthesizing processing of the preview image 81 and the information about finishing, which is necessary when the information about finishing is displayed within the preview image, the preview image is easily generated so that it is possible to shorten processing time, that is, to shorten time required for the display.

Moreover, by performing the finish display out of the recording paper area, even if such post processing unrelated to the image is set after the preview or is canceled to perform the preview display again, what is necessary is only to change the information about finishing out of the recording paper area and it is not necessary to change the preview display within the recording paper area of the preview image. Accordingly, the preview display when performing a resetting therefore can also be performed more quickly than ever.

Also on the preview screen BOA that displays the information about finishing, the display is performed for each page so that the user is able to display a preview image of an arbitrary page by operating the page switch key 72 appropriately, similarly to the case of the preview screen 70 of FIG. 11. Moreover, it is also possible to confirm a currently displayed page of the image data by the page display 79. Further, by operating the enlarging/reducing key 74, the display rotation key 75, or the like appropriately, it is possible to confirm by enlarging, reducing, or rotating the preview image BOA and the preview image 71.

In addition, it is possible to perform a copy by operating the copy start key on the preview screen BOA.

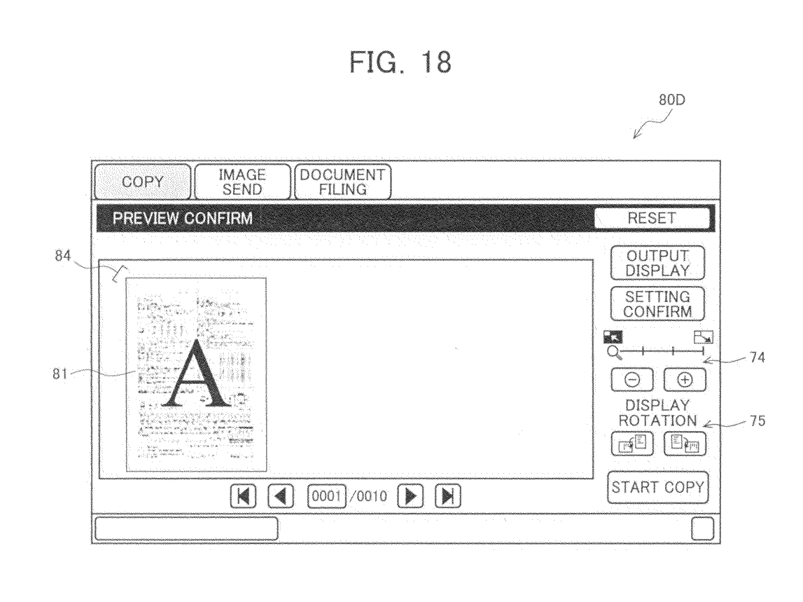

FIG. 16 is a diagram for showing an example in which punch holes are indicated by text on a preview screen that displays information about finishing when punch holes are provided as an output.

Although the punch holes 82 are indicated by circles on the preview screen 80A that displays the information about finishing in FIG. 15, the punch holes can also be indicated by text as shown on a preview screen 80B of FIG. 16. In addition, the punch holes can also be represented by symbols of black circles or double circles or icons. Similarly, it is also possible to use symbols, icons, text, or the like in the case of the staple and the paper fold other than the punch holes as the information about finishing.

Note that, the arrow 82A that indicates a position in a lateral direction of the recoding paper area where the actual punch holes are formed is also displayed out of the recording paper area on the preview screen 80B.

It is also possible to change a display color of symbols, text, and icons showing the information about finishing and to enhance visibility by performing an enhancement display by selecting an appropriate size and color.

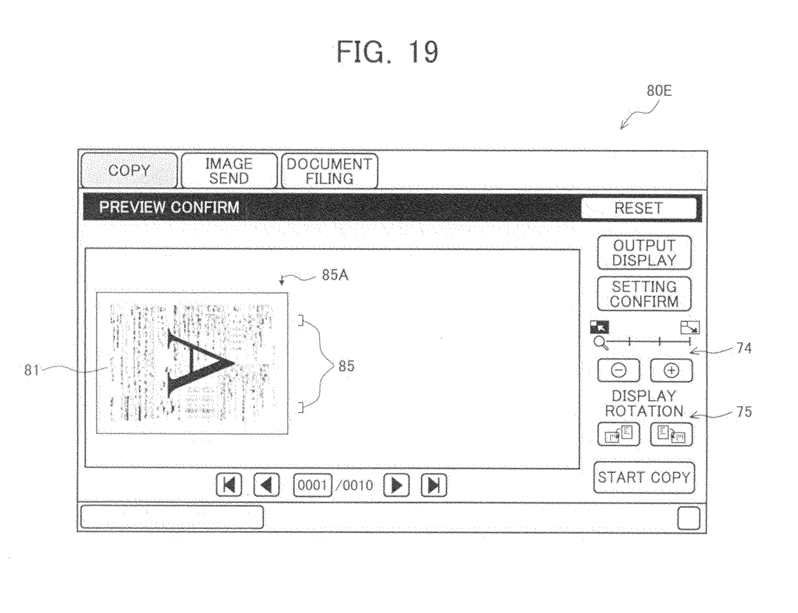

FIG. 17 is a diagram for showing an example of a preview screen that displays information about finishing when a staple is provided as an output.

On a preview screen 80C that displays information about finishing shown in FIG. 17, the preview image 81 is displayed in a direction that an original is read on the reading portion 13. Moreover, on the preview screen 80C, a staple 83 as information about finishing is displayed in a vicinity of the lower left out of the recording paper area of the preview image 81. This shows a preview screen in a case where, on the staple setting screen 60A shown in FIG. 10, when an original is set on the reading portion 13 in reading a copy original, the copy original is set in a direction shown by the key 62C, that is, in a direction where a long side of the original is in the same direction as the reading direction and the key 62C for instructing to apply the staple at one position on the lower left of printed paper is selected.

In this manner, in the example 1, the preview image that displays information about finishing is displayed while keeping a position relation (direction) that the original is read by the reading portion 13 which is an input portion.

This makes it possible for the user to view the preview screen with the original set on the reading portion 13 so that the feeling of incongruity is eliminated.

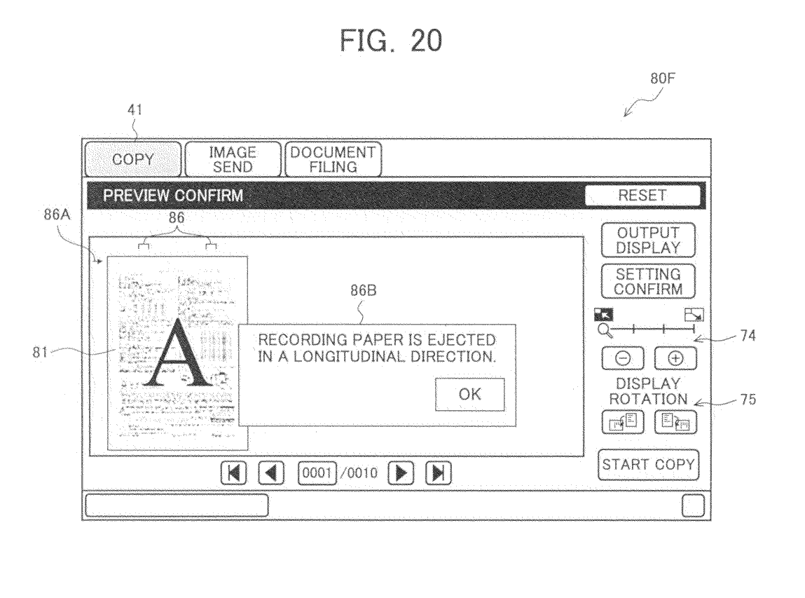

FIG. 18 is a diagram for showing another example of a preview screen that displays information about finishing when a staple is provided as an output.

A preview screen 80D that displays information about finishing shown in FIG. 18 is a display screen when the preview image 81 displayed on the preview screen 80C shown in FIG. 17 is rotated by 90° clockwise by operating the display rotation key 75.

On the preview screen 80D, the preview image 81 is rotated by 90° clockwise and information about finishing 84 is also displayed in a state of being rotated by 90° clockwise while keeping a relative position to the preview image 81.

The preview image 81 is rotated by 90° counterclockwise by operating the display rotation key 75 on the preview screen 80D of FIG. 18 to return to the original preview screen 80C shown in FIG. 17.

Note that, the preview screen 80D of FIG. 18 is the same as the preview screen in a case where, on the staple setting screen 60A shown in FIG. 10, when an original is set on the reading portion 13 in reading a copy original, the copy original is set in a direction where a short side of the original is in the same direction as the reading direction out of directions shown by the key 62A and the key 62A for instructing to apply the staple at one position on the upper left of printed paper is selected.

### Example 2

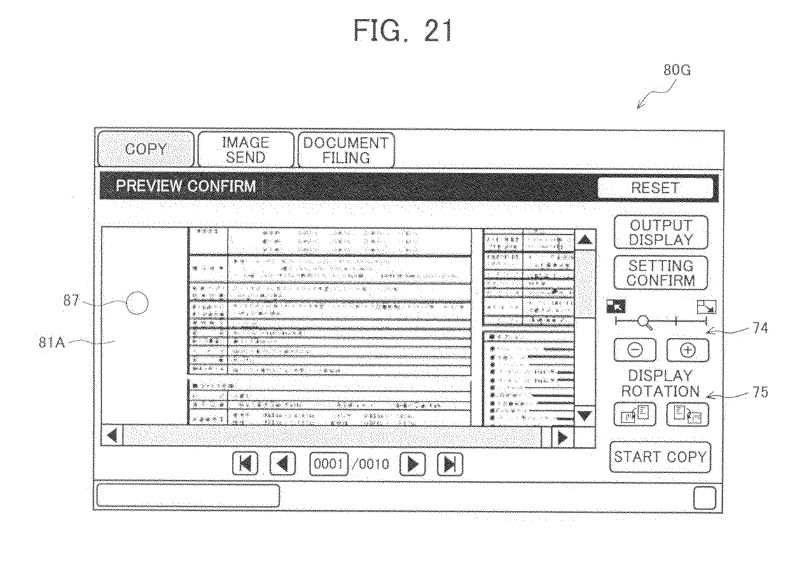

FIG. 19 is a diagram for showing still another example of a preview screen that displays information about finishing when a staple is provided as an output.

On a preview screen 80E shown in FIG. 19, the preview image 81 is displayed while keeping a position relation (direction) that printed paper is ejected.

For example, it is assumed that, on the staple setting screen 60A shown in FIG. 10, when an original is set on the reading portion 13 in reading a copy original, the copy original is set in a direction where a long side of the original is in the same direction as the reading direction out of directions shown by the key 62A and the key 62B for instructing to apply staples at two positions on the left side of printed paper is selected. At this time, two staples are applied on the upper side of the printed paper.

In the post processing apparatus 300 shown in FIG. 3 or the post processing apparatus 301 shown in FIG. 4, a position where a staple is applied to printed paper is at the rear edge part in the paper ejection direction from the arrangement relation of the stapler 172 or 363, and the paper is ejected to the paper ejection tray 175 or 341 in a state where the staple position to the printed paper is at the rear edge part (right side edge part in FIGS. 3 and 4) in the paper ejection direction.

Accordingly, a staple 85 as information about finishing is relatively positioned on the upper side to the direction of the preview image 81 of the original (to “A”) on the preview screen 80E shown in FIG. 19, however, since the staple is on the right side when the paper is ejected to the paper ejection tray, the display is performed so that the position of the staple 81 to the preview image 81 is on the right side.

Note that, on the preview screen 80E, an arrow 85A is displayed out of the recording paper area of the preview image 81 in order to indicate the position in the recording paper area at which the actual staple is provided.

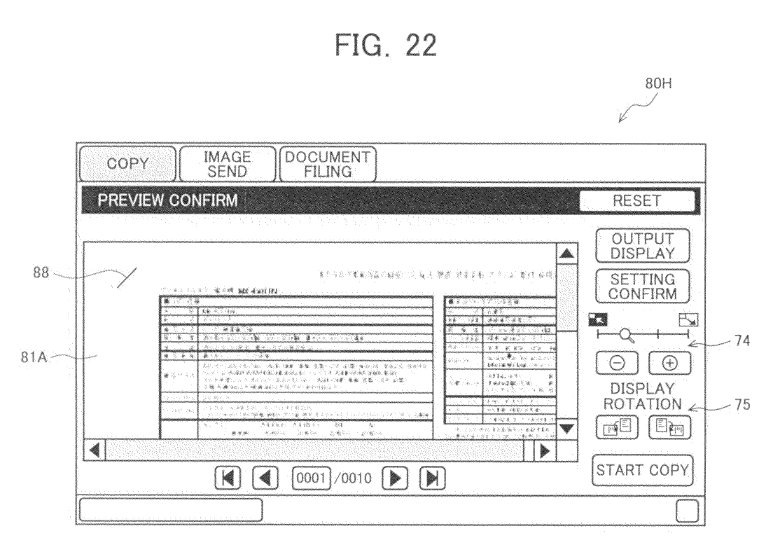

FIG. 20 is a diagram for showing still another example of a preview screen that displays information about finishing when a staple is provided as an output.

A preview screen 80F shown in FIG. 20 is a display screen when the preview image 81 displayed on the preview screen 80E shown in FIG. 19 is rotated by 90° counterclockwise by operating the display rotation key 75. In this case, the preview image 81 is rotated by 90° counterclockwise and a staple 86 as information about finishing is also displayed in a state of being rotated by 90° counterclockwise while keeping a relative position to the preview image 81. Note that, an arrow 86A for indicating a position of the staple is displayed in a state of being rotated by 90° counterclockwise.

When the direction in which printed paper (recording paper) is actually ejected to the paper ejection tray and the direction of the preview image 81 are different from each other in this manner, for example, a message 86B of “Recording paper is ejected in a longitudinal direction.” is displayed as shown on the preview screen 80F of FIG. 20.

Accordingly, since positions at which stapling and punching are possible are specified by the configuration of the post processing apparatus, it is necessary to perform crossfeeding or longitudinal feeding of the recording paper depending on the staple position or the punch position specified by the user and there is a case where the direction is different from the paper ejection direction intended by the user, therefore, it is possible to prevent the user from being confused by previously displaying the message.

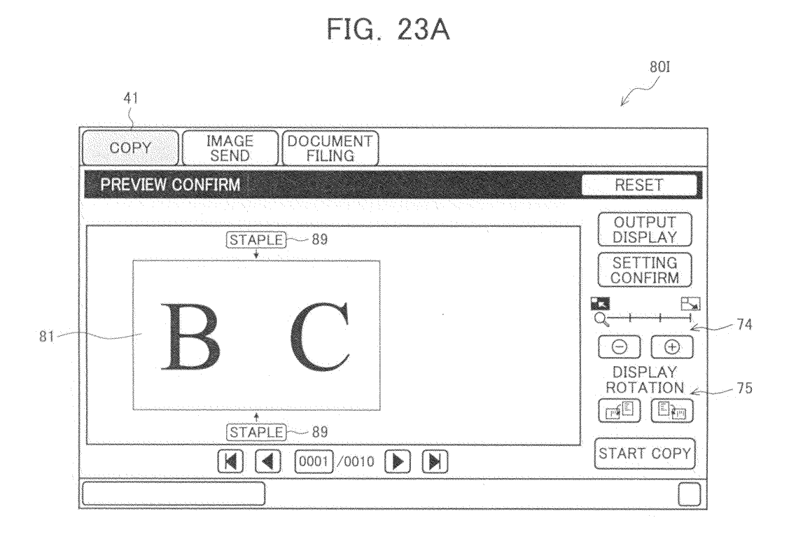

FIG. 21 is a diagram for showing a preview screen when the preview screen shown in FIG. 15 is displayed after enlargement.

By operating the enlarging/reducing key 74 on the preview screen 80A shown in FIG. 15, it is possible to display the preview image 81A that is displayed after enlargement as shown on a preview screen 80G of FIG. 21.

Although the punch holes as information about finishing are displayed out of the recording paper area when the preview image 81 is displayed after reduction, a punch hole 87 is displayed within the recording paper area of the preview image 81A when the preview image 81A is displayed with a predetermined magnifying power or more as shown on a preview screen 80G of FIG. 21. A display size of the punch hole 87 can be displayed at a ratio of the punch hole that is actually provided to the recording paper.

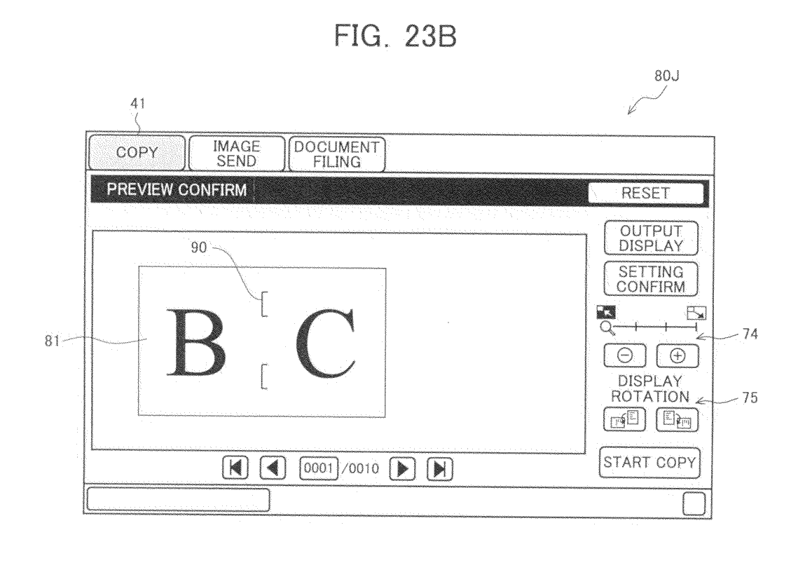

Similarly, FIG. 22 is a diagram for showing a preview screen when the preview screen shown in FIG. 18 is displayed after enlargement.

By operating the enlarging/reducing key 74 on the preview screen 80D shown in FIG. 18, it is possible to display the preview image 81A that is displayed after enlargement as shown on a preview screen 80H of FIG. 22.

Although the staple as information about finishing is shown out of the recording paper area when the preview image 81 is displayed after reduction, a staple 88 is displayed within the recording paper area of the preview image 81A when the preview image 81A is displayed with a predetermined magnifying power or more as shown on the preview screen 80H of FIG. 22. A display size of the staple 88 can be displayed at a ratio of the staple that is actually provided to the recording paper.

This makes it possible to display the actual size of the punch hole and the staple provided in the recording paper to the recording paper and the arrangement relation so that the user is able to grasp the final state in printing accurately.

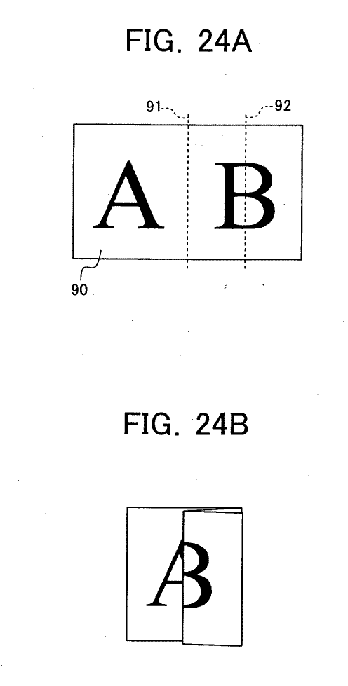

FIG. 23A is a diagram for showing a preview screen that displays a staple as information about finishing when middle staple printing is performed.

On the finish initial screen 60 of FIG. 9, the middle staple key 64 for applying a staple in the center of a copy output of two spread pages to instruct binding in middle position is selected, and by operating the preview confirm key 46 on the standard screen 40 shown in FIG. 7, the preview screen 70 shown in FIG. 11 is displayed and by operating the finish display key 78 on the preview screen 70, a preview screen 80I that displays staples 89 as information about finishing as shown in FIG. 23A can be displayed.

Here, the staples 89 are displayed at two positions on the upper and lower side in the center out of the recording paper area of the preview image 81. Note that, although only the staples 89 are displayed as information about finishing on the preview screen 80I, information about finishing of paper folding may be displayed together as will be described below so that the user is able to grasp the middle binding.

Note that, the staple as information about finishing may be displayed out of one of the recording paper areas among two spread pages as shown as staples 90 in FIG. 23B.

Next, description will be given for a display of information about finishing when a paper fold is set as an output.

By selecting the paper fold key 66 on the finish initial screen shown in FIG. 9, it is possible to set various folding methods with respect to printed paper (recording paper).

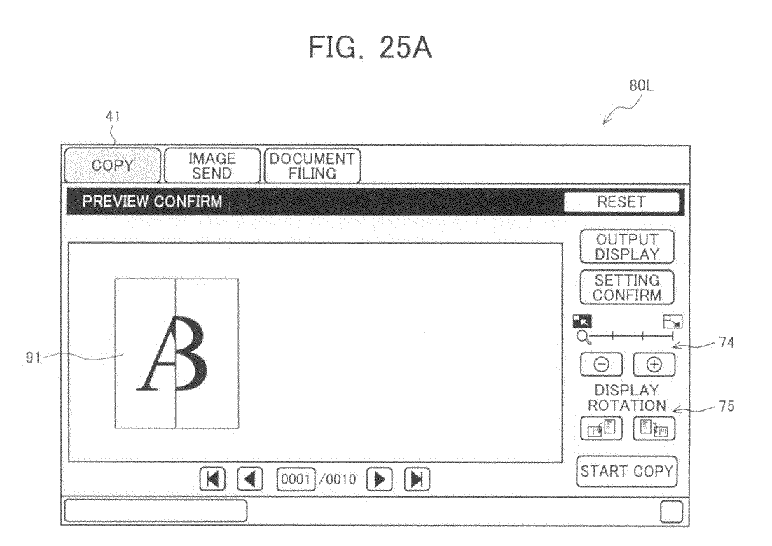

For example, as shown in FIG. 24A, when a so-called Z-shaped fold is set, in which A3-sized recording paper 90 is firstly folded inward in half along center line 91 and a page on the right side indicated by “B” is folded outward along center line 92, the printed paper is ejected with an image as shown in FIG. 24B.

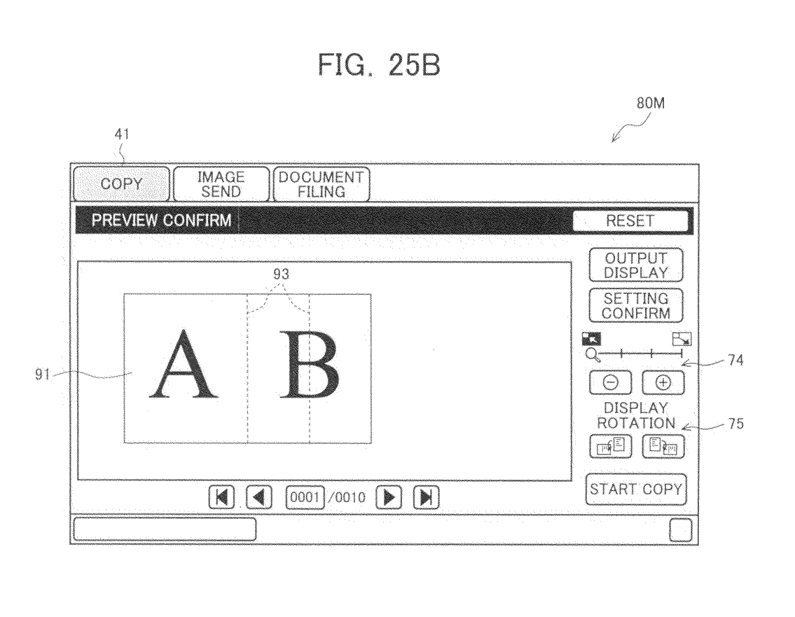

An image that is formed based on an image of printed and ejected recording paper as a preview screen including information about finishing is a preview screen 80L as shown in FIG. 25A, and in a preview image 91, a state of the ejected recording paper can be represented but a display of the folded part can not be confirmed, resulting in an incomplete display.

In order to avoid such a display, it is also considered that an image of recording paper yet to be folded is displayed as the preview image 91 as shown on a preview screen 80M of FIG. 25B and a display is performed with a crease within the recording paper area being represented by dotted line 93, however, there is a problem that it is impossible to discriminate whether the dotted line 93 is displayed as the crease or exists as an actual image.

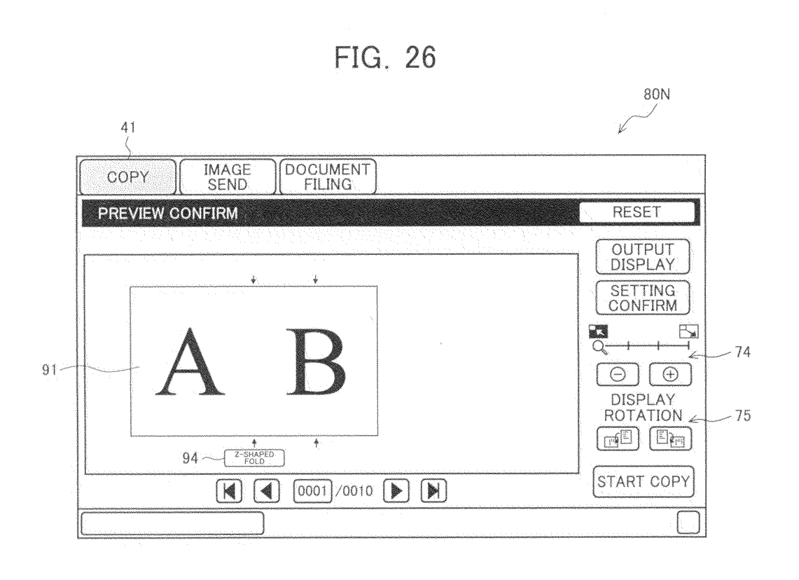

FIG. 26 is an example of a preview screen that displays a Z-shaped fold as information about finishing, which shows an embodiment of the present invention.

On a preview screen 80N shown in FIG. 26, the preview image 91 is displayed in a state before a paper fold is performed, and as to the Z-shaped fold, text 94 of “Z-shaped fold” is displayed out of the recording paper area to show that the Z-shaped fold is performed so that the entire image before folding can be recognized.

Here, the text of “Z-shaped fold” out of the recording paper area allows the user to easily identify that post processing of the “Z-shaped fold” is set. In addition, as shown on the preview screen 80N, a folding part may be displayed with an arrow out of the recording paper area. This makes it possible for the user to easily recognize the folding position. Further, although it is represented by the text 94 of “Z-shaped fold” on the preview screen 80N shown in FIG. 26, it may be represented by text of “Z” or an icon that allows the user to identify the Z-shaped fold.

Also when a folding method other than the Z-shaped fold is set as an output, it is possible for the user to appropriately identify what kind of post processing has been set by displaying “outward fold”, “inward fold”, or the like with the arrow out of the recording paper area.

In the above, although description has been given for the preview display showing a finish state of the present invention taking the digital multi-functional peripheral 1 as an example, such a preview display is also able to be executed by a control program (printer driver) for the digital multi-functional peripheral 1 incorporated in a PC (such as PC 2 or PC 3 of FIG. 1) connected to the digital multi-functional peripheral 1.

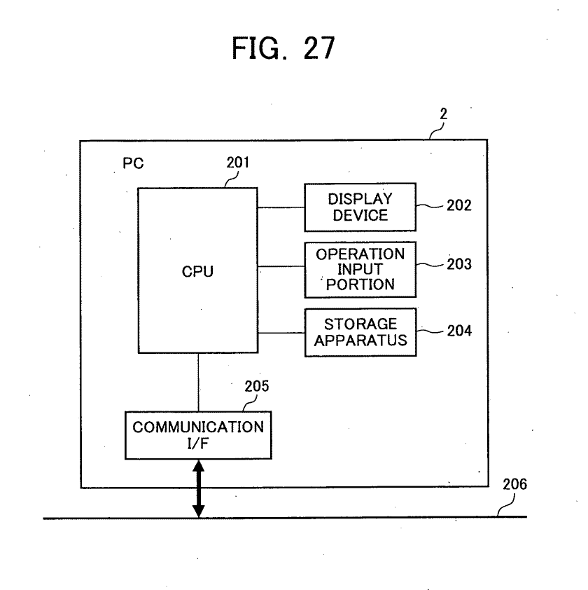

FIG. 27 is a diagram for showing an exemplary configuration of a general PC, which also shows an exemplary configuration of a PC into which a printer driver of the present invention can be incorporated. A PC 2 illustrated in FIG. 27 is provided with a display device 202 which is an example of a display portion, an operation input portion 203 composed of a keyboard, a pointing device, or the like, a storage apparatus 204 composed of a hard disc, a RAM, or a ROM, or the like, a communication I/F 205 for connecting to an external device such as the digital multi-functional peripheral 1 via a network 206, and a CPU 201 for executing various calculation processing to perform control thereof.

An operation system that performs basic control is stored in the ROM or the hard disc so as to be executable by writing on the RAM by the CPU 201. In the hard disc, the printer driver according to the present invention as well as application software such as document creation software and figure creation software is stored similarly, so as to be executable by writing on the RAM by the CPU 201. The printer driver sends a printing command related to image data generated by, for example, document creation software or figure creation software to the digital multi-functional peripheral 1 while communicating with the digital multi-functional peripheral 1 connected by the network 206 or the like through the communication I/F 205. An operation of the application software, a print setting by the printer driver, a preview display, and the like are executed by a user operation from the operation input portion 203.

The printer driver according to the present invention is a program for causing the PC 2 to execute a step of generating a preview image from image data to be output by the digital multi-functional peripheral 1 to display on the display device 202 of the PC 2 and a step of, when the image data to be output the digital multi-functional peripheral 1 outputs with information about finishing added thereto, displaying the information about finishing out of a recording paper area of the preview image in displaying the preview image.

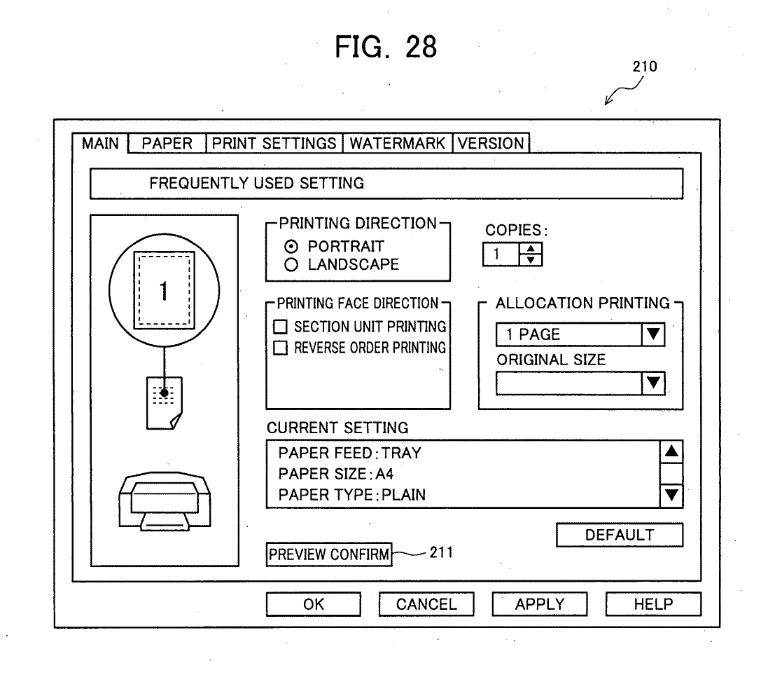

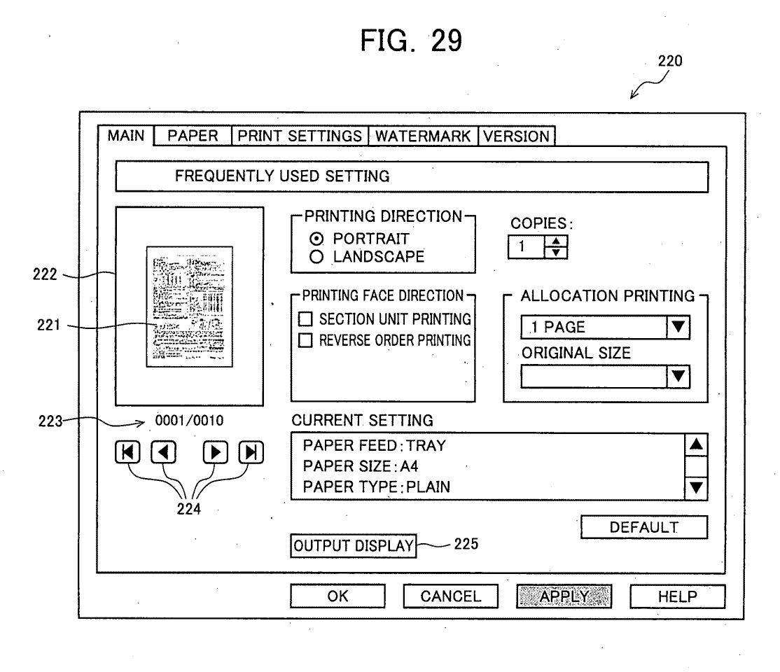

FIGS. 28 to 30 are diagrams for showing an example of a GUI image for setting a series of printing in the print driver according to the present invention. FIG. 28 is an example of a GUI image 210 that is displayed on the display device 202 of the PC 2, and similarly to a general printer driver, a preview confirm key 211 is displayed so as to be selectable in addition to setting items such as a printing direction and the number of printing. The preview confirm key 211 is selected to shift to a GUI image 220 shown in FIG. 29. In the GUI image 220, a preview image 221 generated from image data to be printed is displayed in a preview display area 222, and a page display for showing a currently displayed display page of the preview image 221 and a page switch key 224 for changing a page are also displayed.

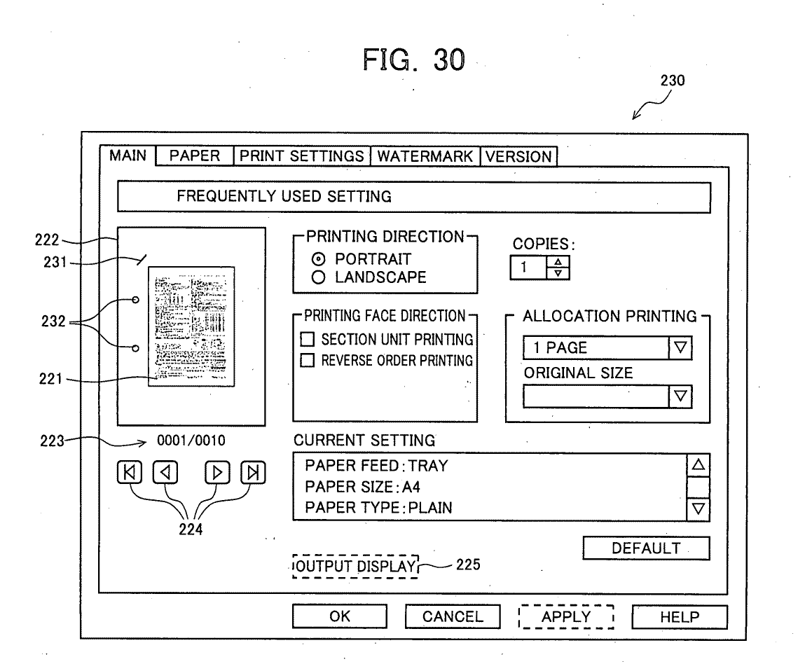

In the GUI image 220, a finish display key 225 is further displayed so as to be selectable. The finish display key 225 is selected to shift to a GUI image 230 shown in FIG. 30. In the GUI image 230, a staple 231 and punch holes 232 showing an existence of information about finishing are displayed out of a recording paper area of the preview image 221 in the preview display area 222 in the same manner as the description for the preview screen shown in FIG. 15. Note that, the finish display key 225 is not selected on the GUI screen 230 that displays a finish.

Although the staple 222 and the punch holes 232 are displayed as information about finishing on the GUI screen 230, similarly to the preview display in the digital multi-functional peripheral 1 described above, an arrow indicating a position of the punch hole and a paper fold are also able to be displayed, and, for example, a display of a predetermined icon or changing of a display color of information about finishing are all applicable in the same manner as the preview display in the digital multi-functional peripheral 1, the description of which will be omitted.

Note that, the printer driver is basically capable of performing all of print settings that can be set on the digital multi-functional peripheral 1 side, and is capable of setting a finish such as a punch hole, a staple, and a paper fold, from another GUI screen, which is not shown.

For example, by selecting an OK key in the GUI image 230, a setting instruction related to a finish is sent to the digital multi-functional peripheral 1 side and printing is executed.

According to the present invention, the following effects may be obtained.

According to the present invention, since information about finishing is displayed out of a recording paper area of a preview image, it is possible to recognize a finish state on a preview screen reliably and to prevent unnecessary image formation processing due to setting errors by a user. In addition, since it is not necessary to synthesize the preview image and the information about finishing to display, the load for generating the preview image is reduced so that preview display time can be shortened.

1. An image forming apparatus provided with a display portion; an operation input portion for performing operation input in accordance with a display of the display portion; an image forming portion for performing image formation of image data; and a display control portion for displaying a preview image of the image data on the display portion before performing the image formation, wherein
when displaying the preview image of the image data on the display portion, information about finishing is displayed out of a recording paper area of the preview image.

2. The image forming apparatus as defined in claim 1, wherein
the information about finishing is information related to a staple, a punch, or a paper fold.

3. The image forming apparatus as defined in claim 1, wherein
the information about finishing is identifiably displayed by a symbol, a text, or an icon.

4. The image forming apparatus as defined in claim 1, wherein
information showing a position at which the information about finishing is applied to the preview image of the image data as well as the information about finishing is displayed out of the recording paper area of the preview image.

5. The image forming apparatus as defined in claim 1, wherein
the information about finishing is emphatically displayed.

6. The image forming apparatus as defined in claim 1, wherein
the preview image of the image data that is displayed on the display portion is able to be displayed after reduction or in enlargement.

7. The image forming apparatus as defined in claim 1, wherein
an input portion for inputting an image of the image data to be displayed for previewing is included.

8. The image forming apparatus as defined in claim 7, wherein
the preview image of the image data that is displayed on the display portion is displayed for previewing in the same direction as an input direction of the image that is input from the input portion.

9. The image forming apparatus as defined in claim 1, wherein
a direction of the preview image of the image data that is displayed on the display portion is decided depending on a paper ejection direction of recording paper.

10. The image forming apparatus as defined in claim 9, wherein
when the direction of the preview image of the image data that is displayed on the display portion is different from the paper ejection direction of the recording paper, a message is displayed.

11. The image forming apparatus as defined in claim 1, wherein
when two pages of image data are displayed in combination as a preview image on the display portion, the information about finishing is displayed out of a recording paper area of one of the image data.

12. The image forming apparatus as defined in claim 7, wherein
the input portion is a scanner apparatus, a storage inside an apparatus, a detachable storage or memory, or a communication line.

13. The image forming apparatus as defined in claim 6, wherein
when the preview image of the image data that is displayed on the display portion is displayed after enlargement with a predetermined magnifying power or more, the information about finishing is displayed within the recording paper area of the preview image.

14. A program to be incorporated into a computer that is connected to an image forming apparatus, wherein
the program causes the computer to execute:
a step of generating a preview image from an image data to be output by the image forming apparatus to display on a display portion of the computer; and
a step of displaying information about finishing out of a recording paper area of the preview image.

15. A preview display method, comprising:
a step in which a computer generates a preview image from image data to be output by an image forming apparatus that is connected to the computer to display on a display portion of the computer, and
a step of displaying information about finishing out of a recording paper area of the preview image.
